(19) United States
(12) Patent Application Publication
(10) Pub. No.: US 2019/0137152 A1
(43) Pub. Date: May 9, 2019

(54) EVAPORATOR UNIT

(71) Applicant: DENSO CORPORATION, Kariya-city (JP)

(72) Inventors: Goki AKIYOSHI, Kariya-city (JP); Kengo KAZARI, Kariya-city (JP); Eiichi TORIGOE, Kariya-city (JP)

(21) Appl. No.: 16/237,771

(22) Filed: Jan. 2, 2019

Related U.S. Application Data
(63) Continuation of application No. PCT/JP2017/020741, filed on Jun. 5, 2017.

(30) Foreign Application Priority Data
Jul. 8, 2016 (JP) 2016-136079

(51) Int. Cl. F25B 39/02; B60H 1/32; F28D 1/053; F28F 9/02

(52) U.S. Cl. CPC F25B 39/028; B60H 1/3202; F25B 39/022; B60H 2001/3298; F28F 9/0253; F28F 9/0278; F28F 9/0217; F28D 1/05341

(57) ABSTRACT

The evaporator unit includes an ejector, a discharge-side evaporator, and a suction-side evaporator. The discharge-side evaporator includes discharge-side tubes and a discharge-side tank. The discharge-side tank defines a discharge-side distribution chamber therein which distributes refrigerant to the discharge-side tubes. A partition plate is disposed in the discharge-side distribution chamber and divides the discharge-side distribution chamber into an ejector-side distribution chamber and a tube-side distribution chamber. The partition plate includes a communication hole through which the ejector-side distribution chamber and the tube-side distribution chamber are in fluid communication with each other. The partition plate includes a first portion, a second portion, a third portion, a fourth portion, and a fifth portion. The communication hole has an open area that is larger in each of the first portion, the third portion and the fifth portion than in each of the second portion and the fourth portion.

### CROSS REFERENCE TO RELATED APPLICATIONS

The present application is a continuation application of International Patent Application No. PCT/JP2017/020741 filed on Jun. 5, 2017, which designated the United States and claims the benefit of priority from Japanese Patent Application No. 2016-136079 filed on Jul. 8, 2016. The entire disclosures of all of the above applications are incorporated herein by reference.

### TECHNICAL FIELD

The present disclosure relates to an evaporator unit for an ejector refrigeration circuit.

### BACKGROUND ART

Ejector refrigeration circuits may be a vapor-compression refrigeration cycle device that has an ejector serving as a refrigerant decompressor. As an example, an ejector refrigeration circuit mounts an evaporator unit that is integrally formed of an ejector, a discharge-side evaporator, and a suction-side evaporator to be a single unit.

### SUMMARY

In one aspect of the present disclosure, an evaporator unit includes an ejector, a discharge-side evaporator, and a suction-side evaporator. The ejector includes a nozzle and a body. The nozzle reduces a pressure of a refrigerant and discharges the refrigerant as an injection refrigerant at a high speed. The body includes a refrigerant suction port and defines a pressure increasing portion therein. The refrigerant suction port draws in the refrigerant as a suction refrigerant using suction force of the injection refrigerant. The pressure increasing portion mixes the injection refrigerant and the suction refrigerant and increases a pressure of the refrigerant including the injection refrigerant and the suction refrigerant. The discharge-side evaporator evaporates the refrigerant flowing out of the pressure increasing portion. The suction-side evaporator evaporates the refrigerant and discharges the evaporated refrigerant to the refrigerant suction port.

The discharge-side evaporator includes discharge-side tubes and a discharge-side tank. The discharge-side tubes are stacked one another along a stacking direction and allow the refrigerant to flow therethrough. The discharge-side tank collects the refrigerant flowing out of the plurality of discharge-side tubes or that distributes the refrigerant to the plurality of discharge-side tubes. The discharge-side tank extends along the stacking direction. The discharge-side tank defines a discharge-side distribution chamber therein which distributes refrigerant flowing out of the pressure increasing portion to the discharge-side tubes.

The ejector is housed in an ejector tank extending parallel to the discharge-side tank. The ejector tank defines an ejector discharge-side chamber therein into which the refrigerant flowing out of the pressure increasing portion flows.

A partition plate is disposed in the discharge-side distribution chamber to partition the discharge-side distribution chamber. The partition plate extends along a longitudinal direction of the discharge-side tank. The partition plate divides the ejector discharge-side chamber into an ejector-side distribution chamber and a tube-side distribution chamber. The refrigerant flowing out of the ejector discharge-side chamber flows into the ejector-side distribution chamber. The refrigerant in the tube-side distribution chamber flows to the discharge-side tubes. The partition plate includes a communication hole through which the ejector-side distribution chamber and the tube-side distribution chamber are in fluid communication with each other. The partition plate is virtually divided into five portions of a first portion, a second portion, a third portion, a fourth portion and a fifth portion arranged in this order along the longitudinal direction from an end of the partition plate adjacent to the ejector, and The communication hole has an open area that is larger in each of the first portion, the third portion and the fifth portion than in each of the second portion and the fourth portion.

The communication hole formed in the partition plate has an open area that is larger in each of the first portion adjacent to the ejector, the third portion at a center of the partition plate along the longitudinal direction, and the fifth portion away from the ejector than in each of the second portion and the fourth portion.

### BRIEF DESCRIPTION OF DRAWINGS

The above and other objects, features and advantages of the present disclosure will become more apparent from the following detailed description referring to the drawings described herein.

FIG. 1 is a diagram of an ejector refrigeration circuit as a whole in a first embodiment.

FIG. 2 is a perspective view of an exterior of an evaporator unit in the first embodiment.

FIG. 3 is a perspective view of an ejector tank, an upper discharge-side tank and an upper suction-side tank of the evaporator unit in the first embodiment.

FIG. 4 is a top view of a plate member in the first embodiment.

FIG. 5 is an enlarged view of a cross-sectional view taken along line V-V shown in FIG. 3 and shows the ejector tank, the upper discharge-side tank, and the upper suction-side tank assembled to each other in the evaporator unit in the first embodiment.

FIG. 6 is an enlarged view of a cross-sectional view taken along line VI-VI shown in FIG. 3 and shows the ejector tank, the upper discharge-side tank, and the upper suction-side tank assembled to each other in the evaporator unit in the first embodiment.

FIG. 7 is an enlarged view of a cross-sectional view taken along line VII-VII shown in FIG. 3 and shows the ejector tank, the upper discharge-side tank, and the upper suction-side tank assembled to each other in the evaporator unit in the first embodiment.

FIG. 8 is a schematic exploded perspective view of a joint of the evaporator unit in the first embodiment.

FIG. 9 is an enlarged plan view of a second plate of the joint of the evaporator unit in the first embodiment.

FIG. 10 is an explanatory view explaining as to how refrigerant flows in the evaporator unit in the first embodiment.

FIG. 11 is a top view explaining as to where second discharge-side communication holes defined in the plate member are open in the first embodiment.

FIG. 12 is a graph showing a relationship between a quantity of the second discharge-side communication holes and a temperature difference ΔT.

FIG. 13 is a top view of a plate member in a second embodiment.

FIG. 14 is a top view of a plate member in a third embodiment.

FIG. 15 is a perspective view of an ejector tank, an upper discharge-side tank and an upper suction-side tank of the evaporator unit in a fourth embodiment.

FIG. 16 is a top view of a plate member in a fifth embodiment.

FIG. 17 is a top view of a plate member in a sixth embodiment.

FIG. 18 is a top view of a plate member in a seventh embodiment.

FIG. 19 is a top view of a plate member in an eighth embodiment.

FIG. 20 is a top view of a plate member in a ninth embodiment.

FIG. 21 is a top view of a plate member in a tenth embodiment.

### EMBODIMENTS FOR CARRYING OUT INVENTION

As an example, an evaporator unit may be integrally formed of an ejector, a discharge-side evaporator, and a suction-side evaporator. The ejector is positioned upstream of the discharge-side evaporator in a flow direction of air. The discharge-side evaporator serves as a heat exchanger that evaporates refrigerant flowing from a pressure increasing portion (i.e., a diffuser portion) of the ejector. The suction-side evaporator is positioned downstream of the discharge-side evaporator in the flow direction of the air. The suction-side evaporator serves as a heat exchanger that evaporates the refrigerant and discharges the evaporated refrigerant toward a refrigerant suction port of the ejector. The ejector is housed in an ejector tank formed into a tubular shape and is coupled integrally with the discharge-side evaporator and the suction-side evaporator.

The discharge-side evaporator and the suction-side evaporator of the evaporator unit form a tank-and-tube heat exchanger. The tank-and-tube heat exchanger includes the ejector tank, a discharge-side tank, a suction-side tank. The discharge-side tank distributes or collects the refrigerant in the discharge-side evaporator. The suction-side tank distributes or collects the refrigerant in the suction-side evaporator. The ejector, the discharge-side evaporator, and the suction-side evaporator are assembled integrally by arranging the tanks to be parallel to each other and coupling the tanks to each other.

In addition, adjacent two tanks of the plurality of tanks are connected to each other by a connector that defines a refrigerant passage therein. The adjacent two tanks are in fluid communication with each other through the refrigerant passage. As such, the ejector, the discharge-side evaporator, and the suction-side evaporator are connected to, i.e., in fluid communication with, each other by the refrigerant passages.

As an example, the ejector tank and the discharge-side tank are connected to each other by a connector defining a refrigerant passage therein. The ejector tank defines a chamber (referred to as an ejector-discharge-side chamber) therein into which the refrigerant flowing out of the ejector flows. The discharge-side tank defines a chamber (referred to as a discharge-side distribution chamber) that distributes the refrigerant to discharge-side tubes of the discharge-side evaporator. The refrigerant passage defined in the connector allows the ejector-discharge-side chamber and the discharge-side distribution chamber to be in fluid communication with each other through the refrigerant passage. As such, the refrigerant flowing out of the ejector flows into the discharge-side evaporator via the refrigerant passage.

Each of the ejector tank and the discharge-side tank extends along a stacking direction in which tubes (referred to as discharge-side tubes) of the discharge-side evaporator are stacked side by side. Moreover, the ejector-discharge-side chamber of the ejector tank and the discharge-side distribution chamber of the discharge-side tank are in fluid communication with each other via a plurality of refrigerant passages arranged along a longitudinal direction of the ejector tank and the discharge-side tank.

The refrigerant flowing out of the ejector may be concentrated in a specified area in the ejector-discharge-side chamber. As such, the refrigerant in the ejector-discharge-side chamber may be hardly distributed to the plurality of refrigerant passages.

As an example, in an operation condition in which inertial force of the refrigerant flowing out of the ejector becomes a specified level, the refrigerant may be concentrated in an area in the ejector-discharge-side chamber away from the ejector. On the other hand, in an operation condition in which a flow speed of the refrigerant flowing out of the ejector is slow, the refrigerant may be concentrated in an area in the ejector-discharge-side chamber close to the ejector.

When the refrigerant is concentrated in a specified area in the ejector-discharge-side chamber, the refrigerant may flow into the discharge-side distribution chamber via the refrigerant passages near the specified area. As such, a distribution may occur in the refrigerant in the discharge-side distribution chamber. The distribution may result in variation in flow rates of the refrigerant flowing from the discharge-side distribution chamber into the discharge-side tubes.

As a result, a distribution in temperature of cooled air cooled in the discharge-side evaporator may occur. The distribution in the temperature of the cooled air results in a distribution in temperature of cooled air cooled in a whole of the evaporator unit.

### First Embodiment

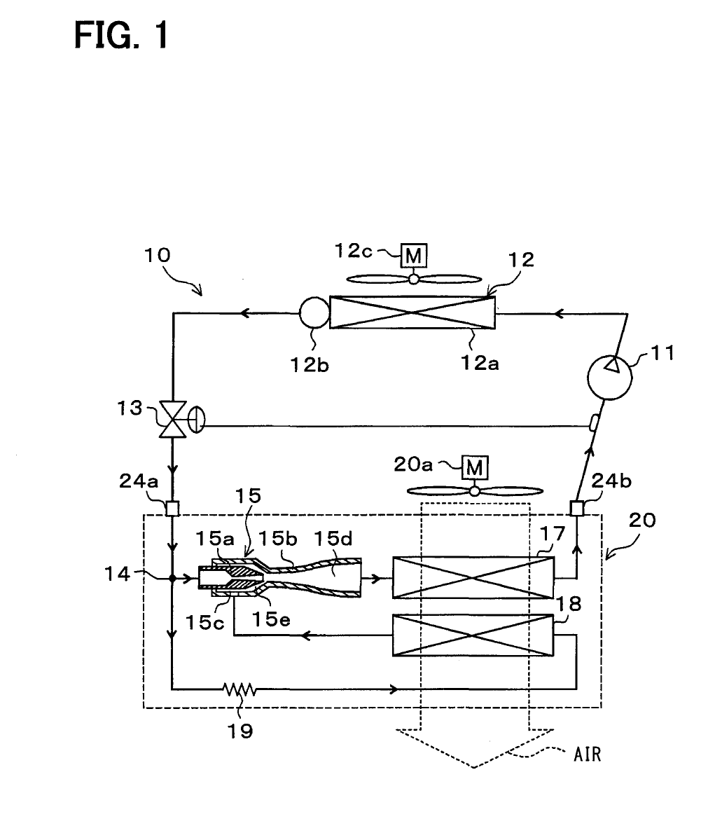

A first embodiment will be described hereafter with reference to FIG. 1 through FIG. 12. In the present embodiment, as shown in FIG. 1, an evaporator unit 20 is mounted to an ejector refrigeration circuit 10. The ejector refrigeration circuit 10 is, in other words, a vapor-compression refrigeration cycle device that has an ejector serving as a refrigerant decompressor. The ejector refrigeration circuit 10 is mounted to an air conditioner for a vehicle and cools air (i.e., supply air) flowing into a cabin of the vehicle. The cabin is a cooling object space. As such, a cooling object fluid to be cooled by the evaporator unit 20 is the air in the present embodiment.

Further, in the ejector refrigeration circuit 10 of the present embodiment, an HFC-based refrigerant (specifically, R134a) is adopted as the refrigerant, and a subcritical refrigeration circuit in which the high-pressure-side refrigerant pressure does not exceed the critical pressure of the refrigerant is constituted. The refrigerant is mixed with refrigerant oil to lubricate a compressor 11. A part of the refrigerant oil circulates in the refrigerant circuit with the refrigerant.

The compressor 11 is one of components forming the ejector refrigeration circuit 10. The compressor 11 draws in the refrigerant, compresses the refrigerant to be the refrigerant having a high pressure, and discharges the refrigerant having the high pressure. Specifically, the compressor 11 is an electric compressor that has a fixed-capacity compression mechanism and an electric motor operating the compression mechanism. The fixed-capacity compression mechanism and the electric motor are housed in a housing of the compressor 11.

Various compression mechanisms such as a scroll type compression mechanism and a vane type compression mechanism may be adopted as the compression mechanism of the compressor 11. In addition, the operation (i.e., rotational speed) of the electric motor is controlled by a control signal output from an air-conditioning controller (not shown), and either an AC motor or a DC motor may be adopted as the electric motor.

A discharge port of the compressor 11 is connected to a refrigerant inlet of a condensing portion 12a of the radiator 12. The radiator 12 is a heat-dissipating heat exchanger that cools the refrigerant having the high pressure by radiating heat of the refrigerant having the high pressure. Specifically, the radiator 12 performs a heat exchange between the refrigerant having the high pressure, which is discharged by the compressor 11, and air (i.e., outside air) taken in from an outside of the cabin so that the refrigerant having the high pressure radiates heat to the outside air. The outside air is taken in by a cooling fan 12c and discharged by the cooling fan 12c toward the radiator 12.

More specifically, the radiator 12 is a condenser integrally formed with a reservoir. The radiator 12 includes the condensing portion 12a and a reservoir 12b. The compressor 11 discharges a gas refrigerant having a high pressure. The condensing portion 12a is a heat exchanging portion that condenses the gas refrigerant having the high pressure by performing a heat exchange between the gas refrigerant having the high pressure and the outside air discharged from the cooling fan 12c. In the heat exchange, the condensing portion 12a radiates heat of the gas refrigerant having the high pressure to condense the gas refrigerant having the high pressure. The reservoir 12b serving as a refrigerant container. Specifically, the reservoir 12b separates the refrigerant flowing out of the condensing portion 12a into gas refrigerant and liquid refrigerant and stores an excess amount of the liquid refrigerant.

The cooling fan 12c is an electric blower. A rotational speed of the cooling fan 12c is controlled by a control voltage output from the air-conditioning controller. The rotational speed is, i.e., a volume of air discharged from the cooling fan 12c.

A refrigerant outlet of the reservoir 12b of the radiator 12 is connected to an inlet of a thermosensitive expansion valve 13. The thermosensitive expansion valve 13 decompresses the refrigerant flowing out of the reservoir 12b of the radiator 12 and controls a flow rate of the refrigerant circulating in the refrigeration circuit. As such, the thermosensitive expansion valve 13 may be referred to as a refrigerant flow control mechanism. In the present embodiment, the thermosensitive expansion valve 13 controls the flow rate of the refrigerant so that a superheat degree of the refrigerant at an outlet of the evaporator unit 20 approaches a reference value.

As an example, the thermosensitive expansion valve 13 includes a thermosensitive portion formed of a displaceable member (e.g., a diaphragm). The displaceable member moves according to a temperature and a pressure of the refrigerant flowing out of the evaporator unit 20. The thermosensitive expansion valve 13, with a mechanical mechanism, controls an opening degree thereof in response to the displacement of the displaceable member so that the superheat degree of the refrigerant at the outlet of the evaporator unit 20 approaches the reference value.

An outlet of the thermosensitive expansion valve 13 is connected to a refrigerant inlet 24a formed in a joint 24 of the evaporator unit 20. Here, the evaporator unit 20 is integrally formed of circuit components assembled to be a single unit. In FIG. 1, the evaporator unit 20 is boxed by a dashed line. Specifically, the evaporator unit 20 is integrally formed of a branch portion 14, an ejector 15, a discharge-side evaporator 17, a suction-side evaporator 18, and a fixed throttle 19.

Components forming the evaporator unit 20 will be described hereafter. The refrigerant from the refrigerant inlet 24a flows into the branch portion 14. The branch portion 14 divides a flow of the refrigerant into one flow and an other flow. The refrigerant of the one flow flows to an inlet of a nozzle 15a of the ejector 15. The refrigerant of the other flow flows to an inlet of the fixed throttle 19.

The ejector 15 serves as a refrigerant decompressor. Specifically, the ejector 15 decompresses, i.e., reduces a pressure of, the refrigerant of the one flow divided by the branch portion 14 to be the refrigerant having a low pressure. The ejector 15 also serves as a refrigerant circulator (or a refrigerant transporter). Specifically, the ejector 15 draws in (or transport) the refrigerant using suction force of the refrigerant discharged from the nozzle 15a at a high speed and results in circulating the refrigerant.

More specifically, the ejector 15 includes the nozzle 15a and a body 15b. The nozzle 15a is made of metal (e.g., stainless alloy or brass) and formed into a tubular shape that is tapered gradually toward a downstream side of a flow direction of the refrigerant. The nozzle 15a defines a refrigerant passage (i.e., a throttle passage) therein. The nozzle 15a decompresses and expands the refrigerant isentropically in the refrigerant passage.

The nozzle 15a includes a throat portion that reduces a passage cross-sectional area of the refrigerant passage. Specifically, the passage cross-sectional area at the throat portion becomes the smallest in the refrigerant passage. The nozzle 15a further includes a diffuser portion that increases the passage cross-sectional area of the refrigerant passage. Specifically, the diffuser portion increases the passage cross-sectional area from the throat portion to a refrigerant injection port of the nozzle 15a from which the nozzle 15a discharges the refrigerant at the high speed. The refrigerant discharged from the nozzle 15a at the high speed will be referred to as injection refrigerant. That is, the nozzle 15a is formed into Laval nozzle.

In the present embodiment, a flow speed of the injection refrigerant discharged from the refrigerant injection port of the nozzle 15a becomes faster than the speed of sound in a normal operation of the ejector refrigeration circuit 10. The nozzle 15a may be formed into a tapered nozzle.

The body 15b is made of metal (e.g., aluminum alloy) and is formed into substantially a tubular shape. The body 15b defines an outer shell of the ejector 15 and serves as a retaining member that supports and fixes the nozzle 15a therein. More specifically, the nozzle 15a is inserted into the body 15b from one side of the body 15b along a longitudinal direction of the body 15b and fixed in the body 15b by a method such as press-fitting. As such, a clearance may not be defined between the nozzle 15a and the body 15b. In other words, the refrigerant is prevented from leaking through the clearance.

A refrigerant suction port 15c is defined in an outer surface of the body 15b facing (i.e., corresponding to) an outer surface of the nozzle 15a. The refrigerant suction port 15c is a through-hole passing through the body 15b so that an inside and an outside of the body 15b are in fluid communication with each other through the refrigerant suction port 15c. Specifically, the refrigerant suction port 15b is in fluid communication with the refrigerant injection port of the nozzle 15a. The refrigerant suction port 15c draws in the refrigerant flowing out of the suction-side evaporator 18 (described later) by using suction force of the injection refrigerant discharged from the nozzle 15a. The refrigerant drawn into the ejector 15 from the refrigerant suction port 15c will be referred to as a suction refrigerant.

The body 15b defines a suction passage 15e and a diffuser portion 15d therein. The suction passage 15e allows the suction refrigerant drawn into the refrigerant suction port 15c to flow to the refrigerant injection port of the nozzle 15a. The diffuser portion 15d mixes the suction refrigerant taken in from the refrigerant suction port 15c and the injection refrigerant discharged from the nozzle 15a in the ejector 15 to be a mixed refrigerant and increases a pressure of the mixed refrigerant.

The suction passage 15e is defined between an outer surface of a tip portion of the tapered nozzle 15a and an inner surface of the body 15b. As such, a passage cross-sectional area of the suction passage 15e decreases gradually toward the downstream side along the flow direction of the refrigerant. As a result, the ejector 15 can increase a flow speed of the suction refrigerant passing through the suction passage 15e. Therefore, an energy loss (i.e., a mixing loss) caused when the suction refrigerant and the injection refrigerant are mixed in the diffuser portion 15d can be reduced.

The diffuser portion 15d is defined to extend from an outlet of the suction passage 15e. The diffuser portion 15d increases a passage cross-sectional area thereof toward the downstream side gradually. As such, the diffuser portion 15d increases a pressure of the mixed refrigerant of the injection refrigerant and the suction refrigerant by reducing a flow speed of the mixed refrigerant while mixing the injection refrigerant and the suction refrigerant. That is, the diffuser portion 15d convers velocity energy of the mixed refrigerant into pressure energy.

More specifically, the inner surface of the body 15b defining the diffuser portion 15d has a cross-sectional shape defined by a plurality of curved lines. The passage cross-sectional area of the diffuser portion 15d increases with a broadening degree of the diffuser portion 15d increased once and decreased subsequently toward the downstream side along the flow direction of the refrigerant. As a result, the diffuser portion 15d can decompress the refrigerant isentropically.

A refrigerant outlet of the diffuser portion 15d is connected to a refrigerant inlet of the discharge-side evaporator 17. The discharge-side evaporator 17 serves as a heat-absorbing heat exchanger. Specifically, the discharge-side evaporator 17 cools air by performing a heat exchange between the air, which flows from the blower fan 20a toward the vehicle compartment, and the refrigerant having the low pressure, which flows out of the diffuser portion 15d. In the heat exchange, the refrigerant having the low pressure is evaporated and absorbs heat from the air. As such, the air is cooled.

The blower fan 20a is an electric blower. A rotational speed of the blower fan 20a is controlled by a control voltage output from the air-conditioning controller. The rotational speed is, i.e., a volume of air discharged from the blower fan 20a. A refrigerant outlet of the discharge-side evaporator 17 is connected to a suction port of the compressor 11 via a refrigerant outlet 24b of the joint 24 of the evaporator unit 20.

The fixed throttle 19 serves as a decompressor. Specifically, the fixed throttle 19 decompresses, i.e., reduces a pressure of, the refrigerant of the other flow divided by the branch portion 14 to be the refrigerant having a low pressure. In the present embodiment, the fixed throttle 19 is formed of an orifice. An outlet of the fixed throttle 19 is connected to a refrigerant inlet of the suction-side evaporator 18.

The suction-side evaporator 18 serves as a heat-absorbing heat exchanger. Specifically, the suction-side evaporator 18 cools air by performing a heat exchange between the air, which flows from the blower fan 20a toward the vehicle compartment and has passed through the discharge-side evaporator 17, and the refrigerant having the low pressure, which flows out of the fixed throttle 19. In the heat exchange, the refrigerant having the low pressure is evaporated and absorbs heat from the air. As such, the air is cooled. A refrigerant outlet of the suction-side evaporator 18 is connected to the refrigerant suction port 15c of the ejector 15.

That is, in the evaporator unit 20, the discharge-side evaporator 17 and the suction-side evaporator 18 are arranged in series with respect to the flow direction of the air. Specifically, the suction-side evaporator 18 is located downstream of the discharge-side evaporator 17 along the flow direction of the air.

The discharge-side evaporator 17 (or a discharge-side evaporator portion) evaporates the refrigerant flowing out of the diffuser portion 15d of the ejector 15. The suction-side evaporator 18 (or a suction-side evaporator portion) evaporates the refrigerant flowing out of the fixed throttle 19 and discharges the evaporated refrigerant toward the refrigerant suction port 15c of the ejector 15.

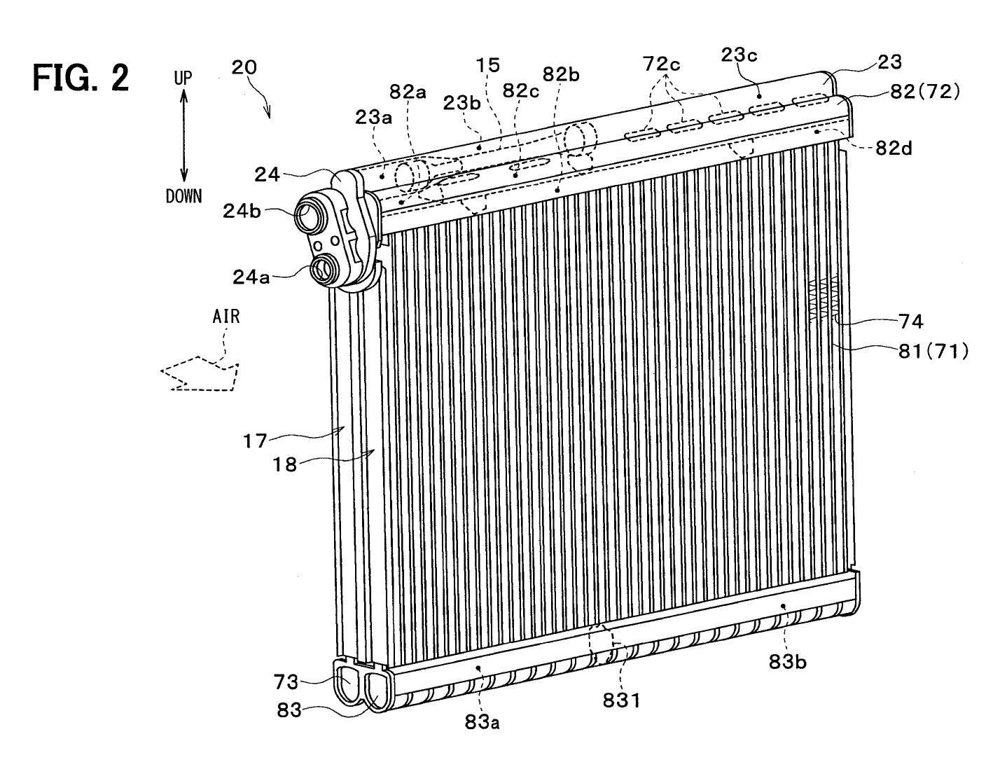

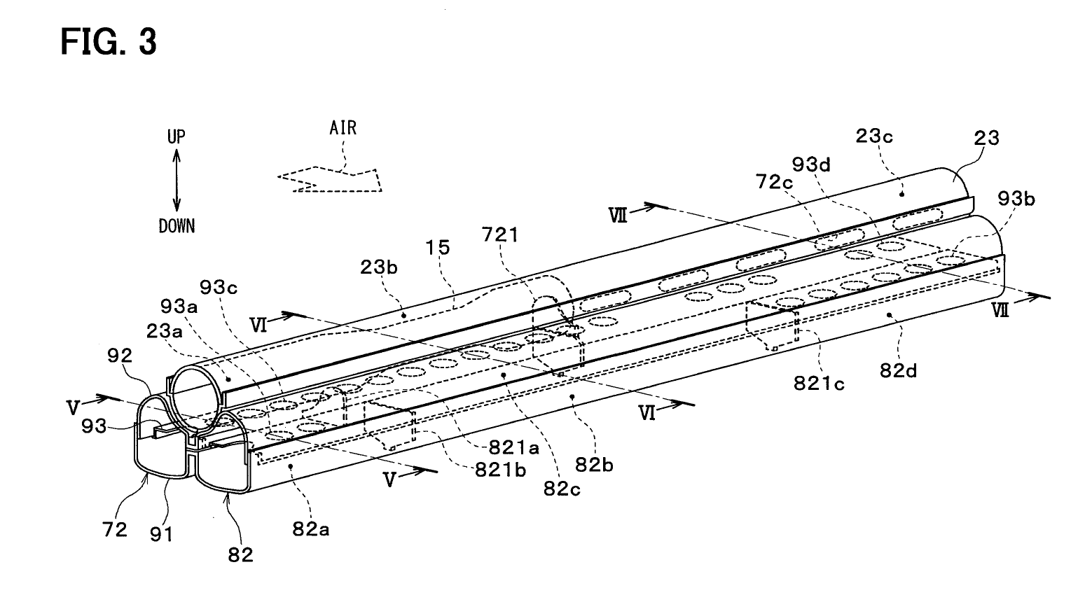

A structure of the evaporator unit 20, i.e., as to how the components are assembled to be a single unit, will be described with reference to FIG. 2 to FIG. 9. FIG. 2 and FIG. 3 includes upward and downward arrows indicating up and down directions of the evaporator unit 20 embodiment mounted to a vehicle in the present embodiment.

In the present embodiment, each of the discharge-side evaporator 17 and the suction-side evaporator 18 is formed into a tank-and-tube heat exchanger. Specifically, the discharge-side evaporator 17 includes a plurality of discharge-side tubes 71 and a pair of discharge-side tanks 72 and 73. The discharge-side tubes 71 allows the refrigerant to pass therethrough. The discharge-side tubes 71 each extends along a longitudinal direction of tube and has one end and an other end facing each other in the longitudinal direction of tube. The two discharge-side tanks 72 and 73 are connected to the one ends and the other ends of the discharge-side tubes 71 respectively. One of the pair of discharge-side tanks 72 and 73 distributes the refrigerant to the discharge-side tubes 71, and the other of the pair of discharge-side tanks 72 and 73 collects the refrigerant flowing out of the discharge-side tubes 71.

Each of the discharge-side tubes 71 is made of metal having a great heat conductivity. In the present embodiment, the discharge-side tubes 71 and the body 15b of the ejector 15 are made of the same metal, i.e., the aluminum alloy. Each of the discharge-side tubes 71 is formed into a flat tube. Specifically, each of the discharge-side tubes 71 has a flat shape in a cross section perpendicular to a flow direction of the refrigerant passing through the discharge-side tube 71, i.e., perpendicular to the longitudinal direction of tube.

The discharge-side tubes 71 are arranged one by one along a stacking direction so that outer flat surfaces (i.e., outer planiform surfaces) are parallel to each other and that the discharge-side tubes 71 are distanced from each other. As such, an air passage is defined between each adjacent two tubes of the discharge-side tubes 71. The air passage allows the air to pass therethrough. Thus, by stacking the discharge-side tubes 71, the discharge-side evaporator 17 has a heat exchanging portion (i.e., a heat exchanging core) that performs the heat exchange between the refrigerant and the air.

A fin 74 promoting the heat exchange between the refrigerant and the air is disposed in the air passage defined between each adjacent two tubes of the discharge-side tubes 71. The fin 74 is formed of a thin plate. The fin 74 is formed into a wave-form fin by bending the thin plate. Bend points of the fin 74 are in contact with the flat surfaces of the adjacent two tubes of the discharge-side tubes 71 by brazing. The discharge-side tubes 71 and the fin 74 may be formed of the same material.

The discharge-side tanks 72 and 73 are formed of a bottomed tubular member. The discharge-side tanks 72 and 73 and the discharge-side tube 71 are made of the same material. Each of the discharge-side tanks 72 and 73 extends along the stacking direction along which the discharge-side tubes 71 are arranged. The one of the pair of discharge-side tanks 72 and 73 defines a distribution chamber therein and distributes the refrigerant in the distribution chamber to the discharge-side tubes 71. The other one of the pair of discharge-side tanks 72 and 73 defines a collection chamber therein and collects the refrigerant flowing out of the discharge-side tubes 71.

In the following description, the pair of discharge-side tanks 72 and 73 will be referred to as an upper discharge-side tank 72 and a lower discharge-side tank 73 for description purpose only. The upper discharge-side tank 72 is located above the discharge-side tubes 71 along the up-down direction. The lower discharge-side tank 73 is located below the discharge-side tubes 71 along the up-down direction.

A base structure of the suction-side evaporator 18 is similar to the above-described structure of the discharge-side evaporator 17. That is, the suction-side evaporator 18 includes a plurality of suction-side tubes 81, a fin 74, and a pair of suction-side tanks 82 and 83. The suction-side tubes 81 allows the refrigerant to pass therethrough. The suction-side tubes 81 each extends along a longitudinal direction of tube and has one end and an other end facing each other in the longitudinal direction of tube. The two suction-side tanks 82 and 83 are connected to the one ends and the other ends of the suction-side tubes 81 respectively. One of the pair of suction-side tanks 82 and 83 distributes the refrigerant to the suction-side tubes 81, and the other of the pair of suction-side tanks 82 and 83 collects the refrigerant flowing out of the suction-side tubes 81. In the following description, the pair of suction-side tanks 82 and 83 will be referred to as an upper suction-side tank 82 and a lower suction-side tank 83 for description purpose only. The upper suction-side tank 82 is located above the suction-side tubes 81 along the up-down direction. The lower suction-side tank 83 is located below the suction-side tubes 81 along the up-down direction.

In the present embodiment, each of the suction-side tubes 81 is formed into a flat tube similar to the discharge-side tubes 71. Since the discharge-side tubes 71 and the suction-side tubes 81 are made of tubes having a common shape. As such, in the evaporator unit 20 in the present embodiment, the manufacturing cost of the evaporator unit 20 as a whole can be reduced by sharing such components.

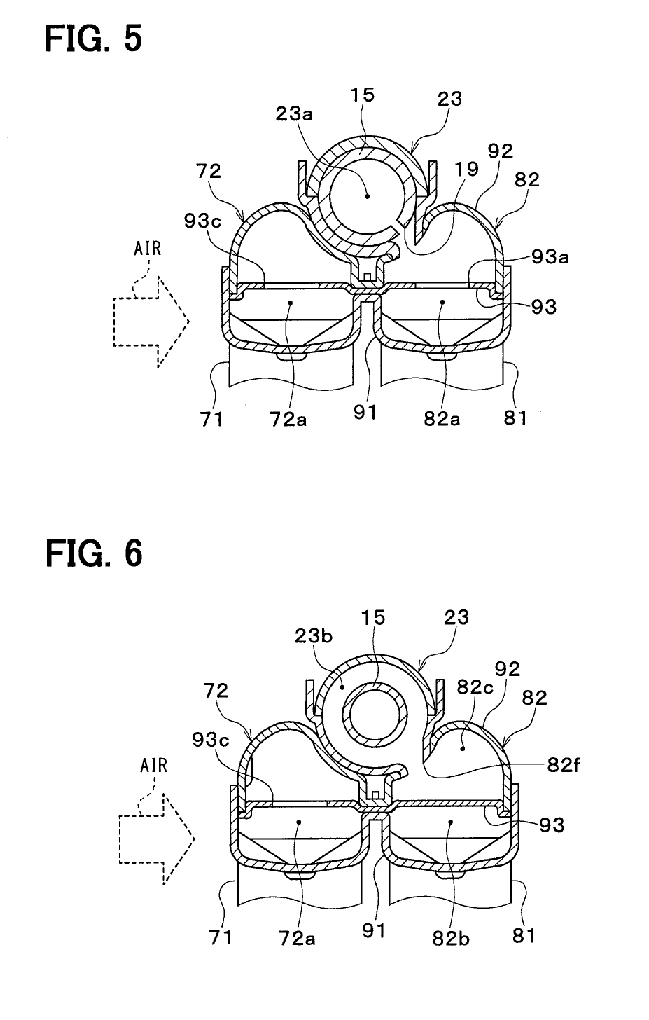

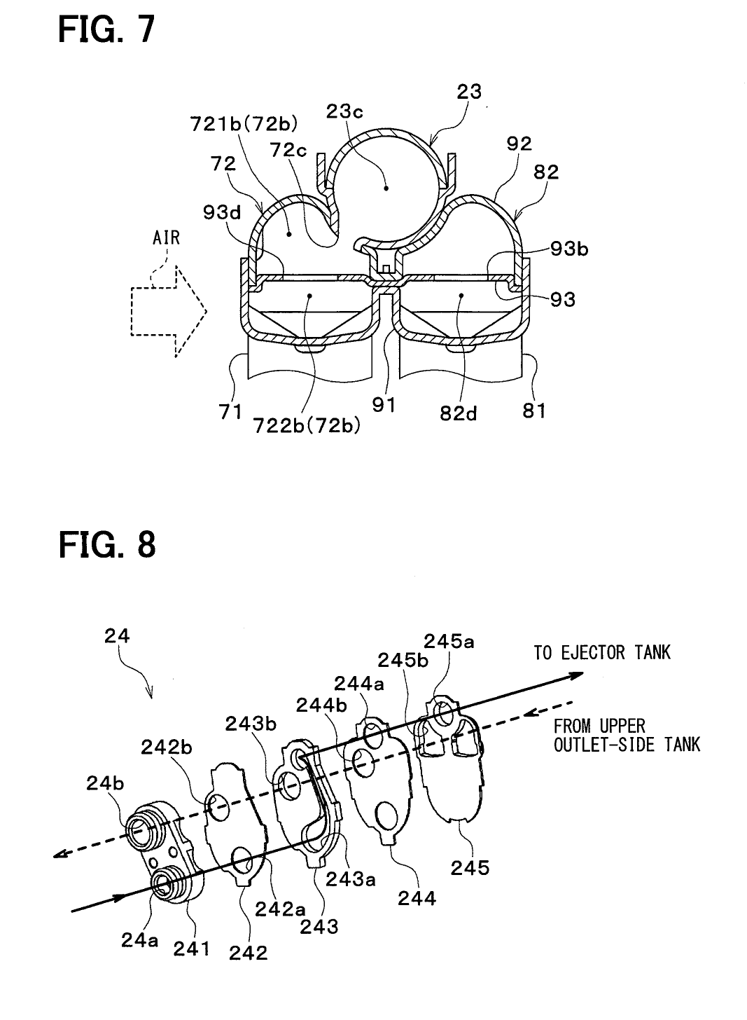

In the present embodiment, the upper discharge-side tank 72 and the upper suction-side tank 82 are assembled integrally by coupling a plate header 91 and a tank header 92 as shown in FIG. 3, FIG. 5, FIG. 6 and FIG. 7.

The plate header 91 includes slits passing therethrough in a thickness direction of the plate header 91. The slits make two lines arranged side by side along the flow direction of the air. In each line, the slits are arranged one by one along a longitudinal direction of the plate header 91. The discharge-side tubes 71 are connected to (e.g., inserted into) the slits in upstream one of the two lines. The suction-side tubes 81 are connected to (e.g., inserted into) the slits in downstream one of the two lines.

As such, the plate header 91 serves as a portion of the upper discharge-side tank 72 adjacent to the discharge-side tubes 71 and a portion of the upper suction-side tank 82 adjacent to the suction-side tubes 81. The portions of the upper discharge-side tank 72 and the upper suction-side tank 82 are, in other words, a lower portion of the upper discharge-side tank 72 and a lower portion of the upper suction-side tank 82 in FIG. 3.

The tank header 92 together with the plate header 91 defines the distribution chamber and the collecting chamber therein by being coupled with the plate header 91. The tank header 92 forms a portion of the upper discharge-side tank 72 away from the discharge-side tubes 71 and a portion of the upper suction-side tank 82 away from the suction-side tubes 81. In other words, the tank header 92 forms an upper portion of the upper discharge-side tank 72 and an upper portion of the upper suction-side tank 82 in FIG. 3.

The lower discharge-side tank 73 and the lower suction-side tank 83 are formed by a common tank header and a common plate header similar to the upper discharge-side tank 72 and the upper suction-side tank 82. The discharge-side evaporator 17 and the suction-side evaporator 18 are integrally formed of the discharge-side tubes 71, the suction-side tubes 81, the discharge-side tanks 72 and 73, the suction-side tanks 82 and 83 (specifically the plate header 91 and the tank header 92), and the fins 74 coupled with each other by brazing.

In FIG. 2, a part of the discharge-side evaporator 17 (i.e., the discharge-side tubes 71 and the upper discharge-side tank 72) is shown with reference numerals in brackets besides reference numerals of a part of the suction-side evaporator 18 corresponding to the part of the discharge-side evaporator 17.

The fins 74 are illustrated only in a portion of the suction-side evaporator 18 in FIG. 2. However, in the discharge-side evaporator 17, the fins 74 and the discharge-side tubes 71 are arranged alternately along the stacking direction, and each of the fins 74 extends along an entire length of each of the discharge-side tubes 71 in the longitudinal direction of tube. Similarly, in the suction-side evaporator 18, the fins 74 and the suction-side tubes 81 are arranged alternately along the stacking direction, and each of the fins 74 extends along an entire length of each of the suction-side tubes 81 in the longitudinal direction of tube.

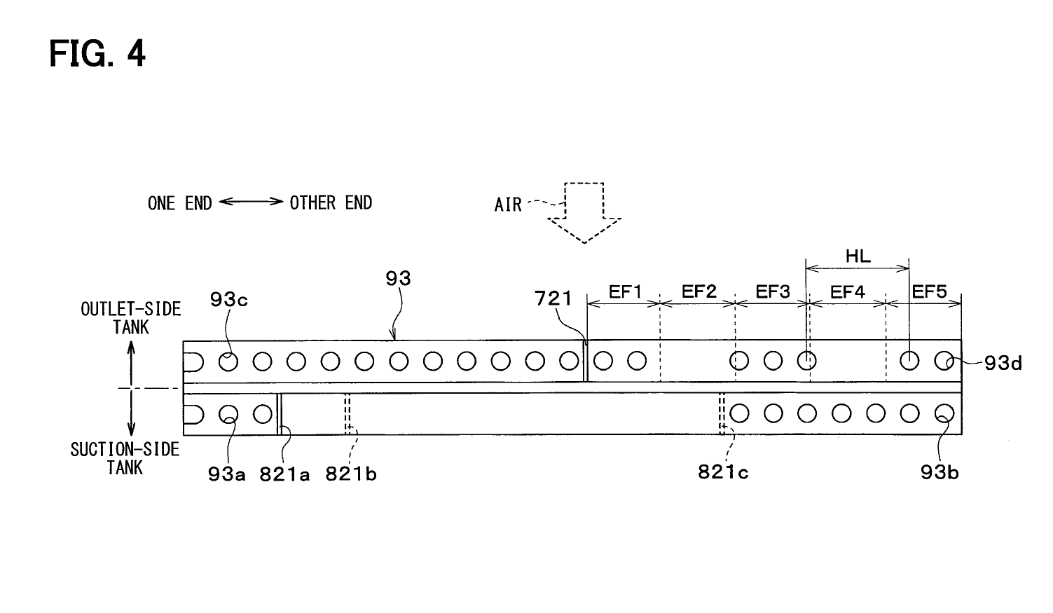

In the present embodiment, as shown in FIG. 3, FIG. 5, FIG. 6 and FIG. 7, the plate member 93 shown in FIG. 4 is interposed between the tank header 92 and the plate header 91. The plate member 93 divides an interior space of the upper discharge-side tank 72 into a chamber adjacent to the discharge-side tubes 71 (i.e., a lower chamber in FIG. 3) and a chamber away from the discharge-side tubes 71 (i.e., an upper chamber in FIG. 3). The plate member 93 also divides an interior space of the upper suction-side tank 82 into a chamber adjacent to the suction-side tubes 81 (i.e., a lower chamber in FIG. 3) and a chamber away from the suction-side tubes 81 (i.e., an upper chamber in FIG. 3).

The plate member 93 includes separators 821a, 821b, 821c, 721. The separators 821a, 821b, 821c, 721 protrude from the plate member 93 along a direction toward the tubes 71 and 81 or in a direction away from the tubes 71 and 81 and divides the interior spaces inside the upper discharge-side tank 72 and the upper suction-side tank 82 into a plurality of chambers. The plate member 93 and the separators 821a, 821b, 821c, 721 each is formed of the same material as the discharge-side tubes 71.

Specifically, as shown in FIG. 3, the separators 821a, 821b, 821c, 721 include a first separator 821a, a second separator 821b, and a third separator 821c that are arranged in this order in the upper suction-side tank 82 from one end toward an other end of the upper suction-side tank 82 along the longitudinal direction of tank. The first separator 821a, the second separator 821b and the third separator 821c are attached to the plate member 93 by brazing. The first separator 821a protrudes from the plate member 93 in the direction away from the tubes 71 and 81. The second separator 821b protrudes from the plate member 93 toward the tubes 71 and 81. The third separator 821c protrudes from the plate member 93 toward the tubes 71 and 81.

As shown in FIG. 4, the plate member 93 includes a plurality of first suction-side communication holes 93a passing through the plate member 93 in the thickness direction of the plate member 93. The first suction-side communication holes 93a are located inside the upper suction-side tank 82 and between the one end of the upper suction-side tank 82 and the first separator 821a along the longitudinal direction of tank. The plate member 93 further includes a plurality of second suction-side communication holes 93b passing through the plate member 93 in the thickness direction of the plate member 93. The second suction-side communication holes 93b are located inside the upper suction-side tank 82 and between the other end of the upper suction-side tank 82 and the third separator 821c along the longitudinal direction of tank.

As such, as shown in FIG. 2 and FIG. 3, the interior space of the upper suction-side tank 82 is divided into four chambers of an one-end-side chamber 82a, an intermediate lower chamber 82b, an intermediate upper chamber 82c, and an other-end side chamber 82d. The one-end-side chamber 82a and the other-end-side chamber 82d are located on the one side and the other side of the upper suction-side tank 82 along the longitudinal direction of tank respectively. The intermediate lower chamber 82b is located adjacent to the tubes 71 and 81 and between the tubes 71 and 81 and the intermediate upper chamber 82c. The intermediate upper chamber 82c and the other-end-side chamber 82d of the upper suction-side tank 82 are in fluid communication with each other directly.

As shown in FIG. 3, the plate member 93 includes a discharge-side separator 721. The discharge-side separator 721 is positioned in the upper discharge-side tank 72. The discharge-side separator 721 is at substantially at the center of the upper discharge-side tank 72 along a longitudinal direction of the upper discharge-side tank 72. The discharge-side separator 721 protrudes from the plate member 93 both in the direction toward the tubes 71 and 81 and in the direction away from the tubes 71 and 81.

As shown in FIG. 4, the plate member 93 includes a plurality of second discharge-side communication holes 93c passing through the plate member 93 in the thickness direction of the plate member 93. The first discharge-side communication holes 93c is located inside the upper discharge-side tank 72 and between the one end of the upper discharge-side tank 72 and the discharge-side separator 721 along the longitudinal direction of tank. The plate member 93 further includes a plurality of second discharge-side communication holes 93d passing through the plate member 93 in the thickness direction of the plate member 93. The second suction-side communication holes 93d are located inside the upper discharge-side tank 72 and between the other end of the upper discharge-side tank 72 and the discharge-side separator 721 along the longitudinal direction of tank.

As such, the interior space of the upper discharge-side tank 72 is divided into a discharge-side collection chamber 72a and a discharge-side distribution chamber 72b.

The communication holes 93a-93d defined in the plate member 93 will be described hereafter in greater detail. As shown in FIG. 4, the communication holes 93a-93d have the same circular shape and the same open area.

A quantity of the first suction-side communication holes 93a is two. A quantity of the second suction-side communication holes 93b is six. The second suction-side communication holes 93b are arranged one by one at regular intervals along the longitudinal direction of the tank inside the upper suction-side tank 82. “At regular intervals” means that center points of the first discharge-side communication holes 93c are evenly spaced from each other.

A quantity of the first discharge-side communication holes 93c is eleven. The first discharge-side communication holes 93c are arranged one by one at regular intervals along the longitudinal direction of tank inside the upper discharge-side tank 72. A quantity of the second discharge-side communication holes 93d are seven. The second discharge-side communication holes 93d are arranged one by one at regular intervals along the longitudinal direction of tank inside the upper discharge-side tank 72.

More specifically, as shown in FIG. 4, a portion of the plate member 93, which divides the interior space of the discharge-side distribution chamber 72b into an upper chamber and a lower chamber, is virtually divided into five portions along the longitudinal direction of tank. The five portions will be hereinafter referred to as a first portion EF1, a second portion EF2, a third portion EF3, a fourth portion EF4 and a fifth portion EF5 arranged in this order from the one side, i.e., from a side adjacent to the refrigerant outlet of the diffuser portion 15d of the ejector 15.

In the present embodiment, the second discharge-side communication holes 93d are arranged so that the open area thereof in each of the first portion EF1, the third portion EF3 and the fifth portion EF5 is greater than each of the open area thereof in the second portion EF2 and the open area thereof in the fourth portion EF4. In other words, a total of the open areas of the second discharge-side communication holes 93d in each of the first portion EF1, the third portion EF3, and the fifth portion EF5 is greater than a total of the open areas of the second discharge-side communication holes 93d in each of the second portion EF2 and the fourth portion EF4.

In the present embodiment, such relationships among the totals of the open areas are obtained with seven second discharge-side communication holes 93d. As an example, for obtaining the relationships among the total of the open areas, eleven upper discharge-side communication holes 93d may be defined at regular intervals along the longitudinal direction of the upper discharge-side tank 72 in the portion of the plate member 93, and third, fourth, eighth and ninth second discharge-side communication holes 93d from the side adjacent to the refrigerant outlet of the diffuser portion 15d of the ejector 15 are closed.

More specifically, in the present embodiment, as shown in FIG. 4, the total of the open areas of the second discharge-side communication holes 93d in the third portion EF3 is the greatest among the totals of the open areas of the second discharge-side communication holes 93d in each of the first portion EF1, the second portion EF2, the fourth portion EF4 and the fifth portion EF5.

In the present embodiment, as shown in FIG. 4, the second discharge-side communication holes 93d include a specified adjacent two holes that are spaced from each other by a largest distance (i.e., a largest interval) HL among the second discharge-side communication holes. When a stacking dimension is defined as a length of a unit quantity (e.g., four in the present embodiment) of the discharge-side tubes 71 along the stacking direction, the largest distance is smaller than the stacking dimension. When defining the stacking direction as a direction along which the discharge-side tubes 71 are stacked side by side, the stacking dimension is a distance, along the stacking direction, between specified points of the two outermost tubes positioned outermost among the unit quantity of the discharge-side tubes 71.

Thus, a portion of the plate member 93 dividing the discharge-side distribution chamber 72b into the upper space and the lower space serves as a partition plate in the present embodiment. The second discharge-side communication holes 93d serves as the communication hole.

As shown in FIG. 2 and FIG. 3, the ejector 15 is housed in the ejector tank 23. The ejector tank 23 is formed of a bottomed tubular member that extends along the longitudinal direction of tank, i.e., longitudinal directions of the upper discharge-side tank 72 and the upper suction-side tank 82. The ejector tank 23 is integrally formed of two divided members assembled to each other. The two divided members are made of the same material as the upper discharge-side tank 72 and the upper suction-side tank 82 and each has a semicircular shape in a cross-section perpendicular to the longitudinal direction of tank.

As shown in FIG. 5 and FIG. 7, the upper discharge-side tank 72 together with the upper suction-side tank 82 defines a recessed area outside the upper discharge-side tank 72 and the upper suction-side tank 82. The ejector tank 23 is positioned in the recessed area when viewed along the longitudinal direction of tank. A portion of an outer surface of the ejector tank 23 is connected to an outer surface of the upper discharge-side tank 72 by brazing, and another portion of the outer surface of the ejector tank 23 is connected to an outer surface of the upper suction-side tank 82 by brazing. As such, the ejector 15 and the ejector tank 23 are integrally coupled with the discharge-side evaporator 17 and the suction-side evaporator 18.

When the ejector tank 23 is coupled with the discharge-side evaporator 17 and the suction-side evaporator 18 by brazing, an outer surface of the ejector 15 is connected to an inner surface of the ejector tank 23 by brazing. As such, an interior space of the ejector tank 23 is divided into an ejector inlet chamber 23a, an ejector suction-side chamber 23b, and an ejector-discharge-side chamber 23c as shown in FIG. 2 and FIG. 3.

The ejector inlet chamber 23a is defined on an upstream side of the nozzle 15a along the flow direction of refrigerant and is located between one end of the ejector tank 23 in the longitudinal direction of tank and the nozzle 15a of the ejector 15. The ejector inlet chamber 23a is in fluid communication with the refrigerant inlet 24a of the joint 24.

The refrigerant flowing out of the diffuser portion 15d flows into the ejector-discharge-side chamber 23c. The ejector-discharge-side chamber 23c is defined between the outlet of the diffuser portion 15d and an other end of the ejector tank 23 along the longitudinal direction of tank. In other words, the ejector-discharge-side chamber 23c is located downstream of the diffuser portion 15d along the flow direction of refrigerant.

The refrigerant flowing into the ejector suction-side chamber 23b is drawn into the ejector 15 from the refrigerant suction port 15c. The ejector suction-side chamber 23b is positioned at the center of the ejector tank 23 along the longitudinal direction of tank and is adjacent to the outer surface of the ejector 15.

As such, the ejector suction-side chamber 23b is located between the ejector inlet chamber 23a and the ejector-discharge-side chamber 23c along the longitudinal direction of tank. The refrigerant suction port 15c of the ejector 15 is open inside the ejector suction-side chamber 23b.

The plurality of chambers defined in the ejector tank 23, the upper discharge-side tank 72 and the upper suction-side tank 82 are in fluid communication with each other via refrigerant passages defined in joints of the ejector tank 23, the upper discharge-side tank 72 and the upper suction-side tank 82.

Specifically, as shown in FIG. 5, the upper suction-side tank 82 defines a one-side chamber 82a adjacent to the one end of the upper suction-side tank 82 along the longitudinal direction of tank. The ejector inlet chamber 23a and the one-side chamber 82a are in fluid communication with each other.

In the present embodiment, the ejector tank 23 includes an opening being open in the ejector inlet chamber 23a, and a portion of the ejector tank 23 defining a rim of the opening is treated with burring. As such, the portion of the ejector tank 23 defining the rim is formed into a flange (i.e., a protrusion) protruding toward the upper suction-side tank 82. The upper suction-side tank 82 includes a communication hole in a portion defining the one-side chamber 82a. The ejector tank 23 is connected to the upper suction-side tank 82 by brazing with the flange of the ejector tank 23 being inserted into the communication hole of the upper suction-side tank 82.

A portion of the ejector 15 defining the ejector inlet chamber 23a and being in fluid communication with the one-side chamber 82a of the upper suction-side tank 82 is formed into the fixed throttle 19 serving as an orifice.

In the present embodiment, the ejector refrigeration circuit 10 has the branch portion 14 that divides the flow of the refrigerant into the one flow and the other flow. The ejector refrigeration circuit 10 can be operated with high coefficient of performance (COP) by adjusting a flow rate Ge/Gnoz between a flow rate of the refrigerant in the one flow and a flow rate of the refrigerant in the other flow to be an appropriate value.

Then, in the present embodiment, flow characteristics of the nozzle 15a and the fixed throttle 19 are set so that COP reaches a maximum value. Gnoz represents the flow rate of the refrigerant flowing from the branch portion 14 to the nozzle 15a of the ejector 15. Ge represents the flow rate of the refrigerant flowing from the branch portion 14 to the fixed throttle 19.

As shown in FIG. 6, the ejector suction-side chamber 23b, which is defined at the center of the ejector tank 23 along the longitudinal direction of tank, and the intermediate upper chamber 82c, which is defined at the center of the upper suction-side tank 82 along the longitudinal direction of tank, are in fluid communication with each other via a suction-side communication path 82f. As such, the intermediate upper chamber 82c is in fluid communication with the refrigerant suction port 15c of the ejector 15 via the ejector suction-side chamber 23b.

As shown in FIG. 7, the ejector-discharge-side chamber 23c and the discharge-side distribution chamber 72b, which is adjacent to the other end of the upper discharge-side tank 72 along the longitudinal direction of tank, are in fluid communication with each other.

More specifically, the discharge-side distribution chamber 72b is divided into two chambers in the up-down direction by the plate member 93. One of the two chambers divided by the plate member 93 is an ejector-side distribution chamber 721b away from the tubes 71 and 81. The other one of the two chambers divided by the plate member 93 is a tube-side distribution chamber 722b adjacent to the tubes 71 and 81. The ejector-discharge-side chamber 23c is in fluid communication with the ejector-side distribution chamber 721b.

The ejector-discharge-side chamber 23c and the discharge-side distribution chamber 72b (i.e., the ejector-side distribution chamber 721b) are in fluid communication with each other through a plurality of refrigerant communication paths 72c. As shown in FIG. 2 and FIG. 3, a quantity of the refrigerant communication paths 72c is more than one (e.g., five in the present embodiment). The refrigerant communication paths 72c are arranged one by one along the longitudinal direction of tank, i.e., longitudinal directions of the ejector tank 23 and the upper discharge-side tank 72.

In the present embodiment, the refrigerant communication paths 72c have the same passage cross-sectional area. The total of the open areas of all of the second discharge-side communication holes 93d is greater than a total of open areas of all of the refrigerant communication paths 72c.

As shown in FIG. 2, a lower suction-side separator 831 is disposed in the lower suction-side tank 83 at the center of the lower suction-side tank 83 along the longitudinal direction of tank. The lower suction-side separator 831 divides an interior space of the lower suction-side tank 83 into two chambers. Specifically, the two chambers are a one-side chamber 83a on the one side and an other-side chamber 83b on the other side along the longitudinal direction of tank.

A structure of the joint 24 will be described hereafter in greater detail. The joint 24 is a connector. The joint 24 includes the refrigerant inlet 24a connected to the outlet of the thermosensitive expansion valve 13 and the refrigerant outlet 24b connected to the suction port of the compressor 11. The joint 24 is made of the same material as the discharge-side evaporator 17 and the suction-side evaporator 18. On the one side along the longitudinal direction, the joint 24 is connected to a side surface of the ejector tank 23, a side surface of the upper discharge-side tank 72 and a side surface of the upper suction-side tank 82 by brazing.

As shown in the exploded perspective view of FIG. 8, the joint 24 is formed of a block member 241 and a plurality of plate members being stacked. The block member 241 includes the refrigerant inlet 24a and the refrigerant outlet 24b. In the present embodiment, a quantity of the plate members is four. That is, the joint 24 is formed of the block member 241, a first plate member 242, a second plate member 243, a third plate member 244, and a fourth plate member 245 being stacked one by one.

The first through fourth plate members 242, 243, 244, 245 include a first inlet hole 242a, a second inlet hole 243a, a third inlet hole 244a, and a fourth inlet hole 245a respectively. When the first through fourth plate members 242, 243, 244, 245 are stacked to form the joint 24, the first to fourth inlet holes 242a, 243a, 244a, 245a form a refrigerant path through which the refrigerant from the refrigerant inlet 24a flows toward the ejector inlet chamber 23a of the ejector tank 23.

The first through fourth plate members 242, 243, 244, 245 also include a first outlet hole 242b, a second outlet hole 243b, a third outlet hole 244b, and a fourth outlet hole 245b respectively. When the first through fourth plate members 242, 243, 244, 245 are stacked to form the joint 24, the first to fourth outlet holes 242b, 243b, 244b, 245b form a refrigerant path through which the refrigerant flowing out of the discharge-side collection chamber 72a of the upper discharge-side tank 72 flows toward refrigerant outlet 24b.

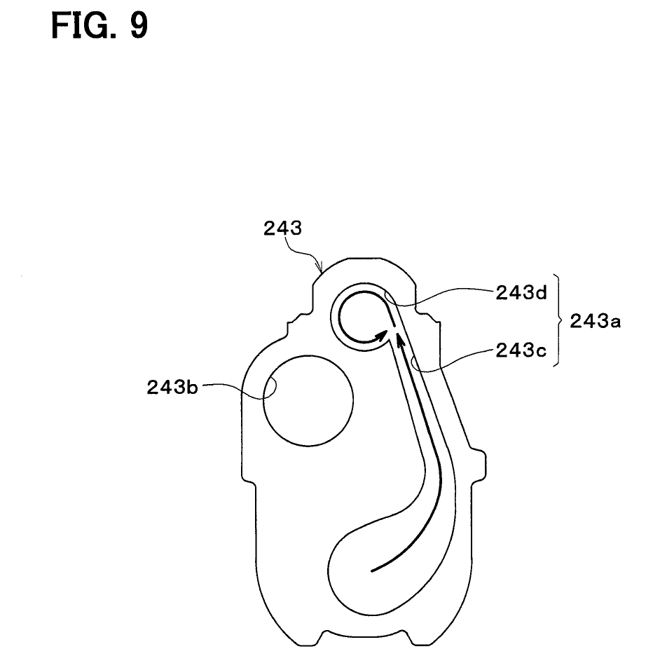

As shown in FIG. 9, the second one of the plate members 242-245 from the block member 241 toward the ejector tank 23 is a second plate 243. The second plate 243 includes a second inlet hole 243a. The second inlet hole 243a is formed of a curved hole 243c and a circular hole 243d. A most-downstream portion of the curved hole 243c along the flow direction of refrigerant extends along a normal direction of a surface defining the circular hole 243d. The surface defining the circular hole 243d is, in other words, a rim of the circular hole 243d.

As shown by solid arrow in FIG. 9, the refrigerant flowing from the first inlet hole 242a of the first plate member 242 into the second inlet hole 243a of the second plate member 243 flows into the circular hole 243d via the curved hole 243c. The refrigerant flowing into the circular hole 243d swirls along the surface defining the circular hole 243d and flows into the third and fourth inlet holes 244a and 245a of the third and fourth plate members 244 and 245 while swirling.

The refrigerant flowing into the third and fourth inlet holes 244a and 245a becomes the refrigerant in gas-liquid two phase due to centrifugal force caused by the swirling. Specifically, in the swirl flow of the refrigerant, gas refrigerant is concentrated around a swirl center line, and liquid refrigerant is concentrated outside the gas refrigerant, as in a gas-liquid separator using centrifugal force. The refrigerant in the gas-liquid two phase flows into the ejector inlet chamber 23a of the ejector tank 23.

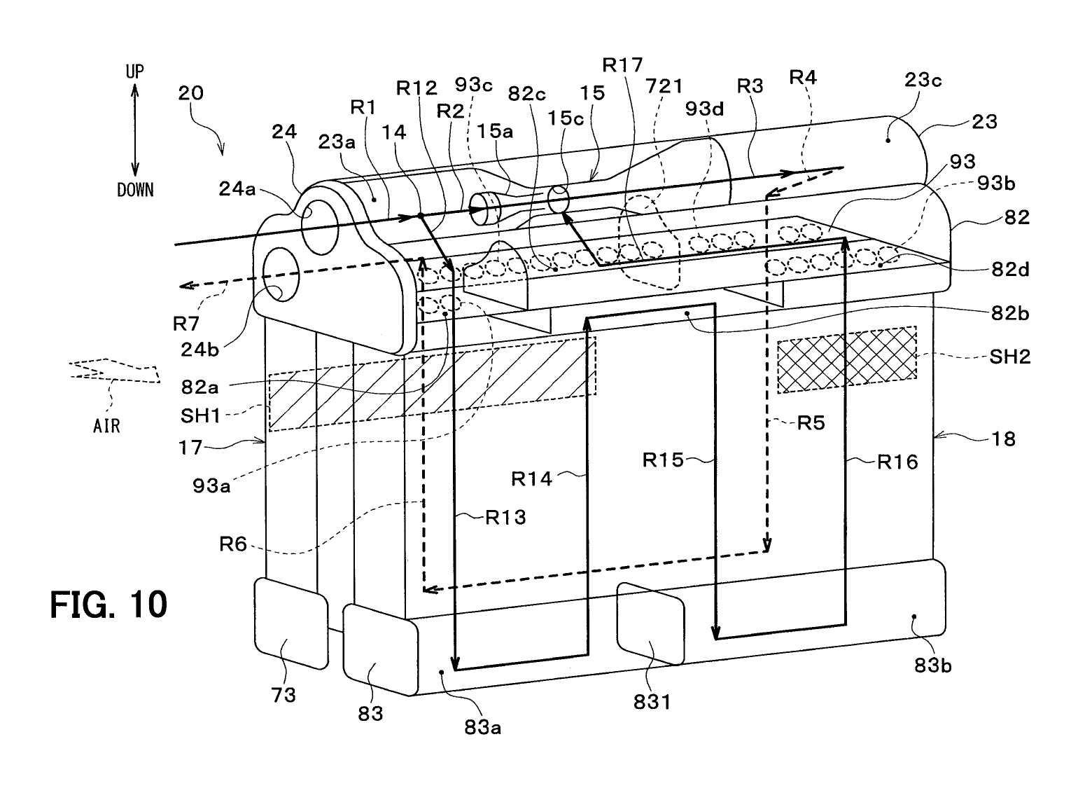

The evaporator unit 20 is formed as a single unit as described above. Refrigerant passages in the evaporator unit 20 will be described hereafter in greater detail with reference to the explanatory view of FIG. 10. The refrigerant flows from the refrigerant inlet 24a of the joint 24 into the ejector inlet chamber 23a of the ejector tank 23 as shown by indicator arrow R1 in FIG. 10.

A flow of the refrigerant flowing into the ejector inlet chamber 23a is divided into a flow of the refrigerant flowing into the nozzle 15a of the ejector 15 as shown by indicator arrow R2 and a flow of the refrigerant flowing into the one-side chamber 82a of the upper suction-side tank 82 via the fixed throttle 19 as shown by indicator arrow R12. That is, the branch portion 14 is positioned inside the ejector inlet chamber 23a in the present embodiment.

Since the refrigerant is swirling in the ejector inlet chamber 23a, the liquid refrigerant, which is concentrated near the inner surface of the ejector tank 23 defining the ejector inlet chamber 23a due to centrifugal force, flows out of the ejector inlet chamber 23a toward the fixed throttle 19 preferentially, in the present embodiment. As such, the rest of the refrigerant in the gas-liquid two-phase flows into the nozzle 15a of the ejector 15 preferentially.

Thus, in the present embodiment, the refrigerant path defined by the second to fourth inlet holes 243a, 244a and 245a of the joint 24 serves as a swirl flow generator that causes the swirl flow of the refrigerant in the ejector inlet chamber 23a providing the branch portion 14.

The refrigerant flowing into the nozzle 15a of the ejector 15 is mixed with the suction refrigerant drawn in from the refrigerant suction port 15c to be the mixed refrigerant and flows out of the ejector 15 from the diffuser portion 15d. The refrigerant flowing from the diffuser portion 15d flows into the ejector discharge-side chamber 23c of the ejector tank 23 as shown by indicator arrow R3.

The refrigerant flowing into the ejector-discharge-side chamber 23c flows into the ejector-side distribution chamber 721b of the discharge-side distribution chamber 72b via the refrigerant communication paths 72c as shown by dashed indicator arrow R4. The refrigerant flowing into the ejector-side distribution chamber 721b flows into the tube-side distribution chamber 722b via the second discharge-side communication hole 93d of the plate member 93.

The refrigerant flowing from the ejector-side distribution chamber 721b to the tube-side distribution chamber 722b is easily distributed to the first portion EF1, the third portion EF3 and the fifth portion EF5 via the second discharge-side communication hole 93d of the plate member 93. The first portion EF1 is nearest to the ejector 15 in the discharge-side distribution chamber 72b. The third portion EF3 is at the center of the discharge-side distribution chamber 72b along the longitudinal direction of tank. The fifth portion EF5 is furthermost from the ejector 15 in the discharge-side distribution chamber 72b.

Specifically, since the total of the open areas of the second discharge-side communication holes 93d in the third portion EF3 is the greatest, the refrigerant is distributed to the third portion EF3 easily. The third portion EF3 is at the center of the discharge-side distribution chamber 72b along the longitudinal direction of tank.

As shown by dashed indicator arrow R5, the refrigerant flowing into the tube-side distribution chamber 722b passes through the discharge-side tubes 71, which are in fluid communication with the discharge-side distribution chamber 72b, from an upper end to a lower end and then flows into the lower discharge-side tank 73. The refrigerant flowing into the lower discharge-side tank 73 flows through the lower discharge-side tank 73 from the other end to the one end along the longitudinal direction of tank and then flows into the discharge-side tubes 71 being in fluid communication with the discharge-side collection chamber 72a.

As shown by dashed indicator arrow R6, the refrigerant flowing into the discharge-side tubes 71 being fluid communication with the discharge-side collection chamber 72a passes through the discharge-side tubes 71 from a lower end to an upper end, and then flows into the discharge-side collection chamber 72a of the upper discharge-side tank 72. As shown by dashed indicator arrow R7, the refrigerant flowing into the discharge-side collection chamber 72a flows out from the refrigerant outlet 24b of the joint 24 since the plate member 93 includes the first discharge-side communication hole 93c.

Here, the thermosensitive expansion valve 13 adjusts the superheat degree of the refrigerant at the outlet of the evaporator unit 20 to approach the reference superheat degree in the present embodiment. As such, the refrigerant in the discharge-side collection chamber 72a becomes the vapor refrigerant at the superheat degree. As a result, the discharge-side evaporator 17 includes an upstream superheated area SH1 through which the gas refrigerant having the superheat degree passes. The upstream superheated area SH1 is shown by a shaded area with shaded hatching in FIG. 10.

In addition, the plate member 93 includes the first suction-side communication hole 93a. As such, the refrigerant flowing from the ejector inlet chamber 23a into the one-side chamber 82a of the upper suction-side tank 82 via the fixed throttle 19 flows into the suction-side tubes 81 being in fluid communication with the one-side chamber 82a. Then, as shown by indicator arrows R13, R14, R15 and R16, the refrigerant turns three times to draw W and then flows into the other-side chamber 82d of the upper suction-side tank 82

More specifically, the refrigerant flowing into the one-side chamber 82a of the upper suction-side tank 82 flows through the one-side chamber 82a of the upper suction-side tank 82, a first group of the suction-side tubes 81 (see indicator arrow R13), the one-side chamber 83a of the lower suction-side tank 83, a second group of the suction-side tubes 81 (see indicator arrow R14), the tube-side chamber 82b, a third group of the suction-side tubes 81 (see indicator arrow R15), the other-side chamber 83b of the lower suction-side tank 83, a fourth group of the suction-side tubes 81 (see indicator arrow R16), and the other-side chamber 82d of the upper suction-side tank 82 in this order.

As shown by indicator arrow R17, the refrigerant flowing into the other-side chamber 82d of the upper suction-side tank 82 flows to the refrigerant suction port 15c of the ejector 15 via the intermediate upper chamber 82c since the plate member 93 includes the second suction-side communication hole 93b.

In the present embodiment, the refrigerant drawn in from the refrigerant suction port 15c is the gas refrigerant having a superheat degree. As a result, the suction-side evaporator 18 includes an downstream superheated area SH2 through which the gas refrigerant having the superheat degree passes. The downstream superheated area SH1 is shown by a shaded area with hatching in FIG. 10. Therefore, when viewed along the flow direction of the air, the upstream superheated area SH1 and the downstream superheated area SH2 do not overlap with each other.

An electronic control unit of the ejector refrigeration circuit 10 in the present embodiment will be described hereafter. The air conditioning controller (not shown) includes a known microcomputer which includes a CPU, a ROM, and a RAM and a peripheral circuit thereof, and performs various calculations and processes in accordance with control programs stored in the ROM to control the operations of various devices connected to the output side. The various devices are, e.g., the compressor 11, the cooling fan 12c, and the blower fan 20a.

Various sensors are connected to the air-conditioning controller so that detected values detected by the sensors are input to the air-conditioning controller. The various sensors may be an inside-air temperature sensor that detects a temperature of the inside air in the cabin, an outside-air temperature sensor that detects a temperature of the outside air, an insolation sensor that detects an amount of insolation in the cabin, and an evaporator temperature sensor that detects a temperature (or an evaporator temperature) of air flowing out of the evaporator unit 20.

The air-conditioning controller has an input end connected with an operation panel (not shown) and receives operation signals from various operation switches provided with the operation panel. The various operation switches provided with the operation panel include an air conditioning operation switch to be operated to request air conditioning of the cabin and an inside-air temperature setting switch operated to set a temperature in the cabin.

Here, the air-conditioning controller of the present embodiment integrally includes a control unit that controls the operation of various control target devices connected to its output side. In the air-conditioning controller, configurations (hardware and software) that control the operation of each of the control target devices constitute a control unit of the control target devices. For example, in the present embodiment, the configuration for controlling the refrigerant discharge capacity of the compressor 11 forms the discharge capacity control unit.

Operations of the ejector refrigeration circuit 10 in the present embodiment will be described hereafter. When the air conditioning switch of the operation panel is operated (i.e., turned on), the air-conditioning controller operates the compressor 11, the cooling fan 12c, the blower fan 20a or the like.

The compressor 11 draws the refrigerant, compresses the refrigerant to be the refrigerant having a high temperature and a high pressure, and discharges the refrigerant having the high temperature and the high pressure. The refrigerant having the high temperature and the high pressure discharged from the compressor 11 flows into the radiator 12. The radiator 12 condenses the refrigerant having the high temperature and the high pressure in the condensing portion 12a by performing a heat exchange between the refrigerant and the outside air flowing from the cooling fan 12c. The refrigerant cooled in the condensing portion 12a is divided into gas refrigerant and liquid refrigerant in the receiver 12b.

The liquid refrigerant separated in the receiver 12b flows into the thermosensitive expansion valve 13 and is decompressed. An opening degree of the thermosensitive expansion valve 13 is adjusted so that the superheat degree of the refrigerant at the outlet of the evaporator unit 20 approaches a reference superheat degree. The decompressed refrigerant decompressed in the thermosensitive expansion valve 13 flows into the refrigerant inlet 24a of the evaporator unit 20.

A flow of the refrigerant flowing into the evaporator unit 20 is divided into one flow and the other flow of the refrigerant in the branch portion 14. The branch portion 14 is disposed in the ejector inlet-side chamber 23a of the ejector tank 23. The refrigerant of the one flow flows into the nozzle 15a of the ejector 15. The nozzle 15a decompresses the refrigerant isentropically and discharges the decompressed refrigerant as the injection refrigerant. The refrigerant suction port 15c of the ejector 15 draws in the refrigerant from the suction-side evaporator 18 by using suction force of the injection refrigerant.

The injection refrigerant discharged from the nozzle 15a and the suction refrigerant drawn in from the refrigerant suction port 15c flow into the diffuser portion 15d of the ejector 15. Since the diffuser portion 15d increases the passage cross-sectional area thereof, velocity energy of the refrigerant is converted into pressure energy. As such, a pressure of the mixed refrigerant of the injection refrigerant and the suction refrigerant rises.

The refrigerant flowing out of the diffuser portion 15d flows into the discharge-side evaporator 17. The refrigerant flowing into the discharge-side evaporator 17 absorbs heat from the air flowing from the blower fan 20a and thereby being evaporated. As such, the air flowing from the blower fan 20a is cooled. The refrigerant flowing out of the discharge-side evaporator 17 is drawn into the compressor 11 via the refrigerant outlet 24b of the evaporator unit 20 and is compressed again.

The refrigerant of the other flow divided in the branch portion 14 flows into the fixed throttle 19. The fixed throttle 19 decompresses the refrigerant isenthalpically. The decompressed refrigerant flows into the suction-side evaporator 18. The suction-side evaporator 18 evaporates the refrigerant by performing a heat exchange between the refrigerant and air after passing through the discharge-side evaporator 17 so that the refrigerant absorbs heat from the air. As such, the air after passing through the discharge-side evaporator 17 is further cooled. The refrigerant suction port 15c of the ejector 15 draws in the refrigerant flowing out of the suction-side evaporator 18.

Thus, according to the ejector refrigeration circuit 10 in the present embodiment, the evaporator unit 20 cools the air flowing into the cabin.

In addition, according to the ejector refrigeration circuit 10 in the present embodiment, the refrigerant flows out of the refrigerant outlet 24b located downstream of the discharge-side evaporator 17. As such, the compressor 11 draws in the refrigerant, a pressure of which is increased in the diffuser portion 15d of the ejector 15.

Accordingly, power consumption of the compressor 11 is reduced, and therefore coefficient of performance (COP) of the ejector refrigeration circuit 10 is improved as compared to conventional refrigeration cycle devices in which a refrigerant evaporation pressure in an evaporator becomes equal to a pressure of the suction refrigerant.

In the evaporator unit 20 in the present embodiment, a pressure at which the refrigerant is evaporated in the discharge-side evaporator 17 becomes equal to a pressure of the refrigerant increased in the diffuser portion 15d. In addition, a pressure at which the refrigerant is evaporated in the suction-side evaporator 18 connected to the refrigerant suction port 15c of the ejector 15 becomes a low pressure of the refrigerant immediately after decompressed in the nozzle 15a.

As such, when viewed along the flow direction of the air, a difference between a temperature at which the refrigerant is evaporated and a temperature of the air can be secured in each of the discharge-side evaporator 17 and the suction-side evaporator 18. As a result, the air can be cooled effectively.

Therefore, according to the evaporator unit 20 in the present embodiment, the upstream superheated area SH1 and the downstream superheated area SH2 do not overlap with each other when viewed along the flow direction of the air. As such, an occurrence of a distribution in temperature of the air cooled in the evaporator unit 20 can be suppressed.

However, it may be difficult to distribute the refrigerant to the plurality of refrigerant communication paths 72c through which the ejector discharge-side chamber 23c and the discharge-side distribution chamber 72b are in fluid communication with each other since the refrigerant communication paths 72c are arranged one another along the longitudinal direction of the ejector tank 23 and the upper discharge-side tank 72 in the evaporator unit 20 in the present embodiment. As such, the occurrence of the distribution in temperature of the air cooled in the evaporator unit 20 may not be suppressed.

The reason is that the refrigerant flowing out of the ejector 15 tends to be concentrated in a part of the ejector discharge-side chamber 23c.

For example, since the ejector tank 23 is formed into a tubular shape, a bottom portion of the ejector tank 23 serves as a watershoot and guides the refrigerant flowing out of the ejector 15 to flow away from the ejector 15, in an operational condition in which a thermal load of the ejector refrigeration circuit 10 is relatively small, a volume of the refrigerant circulating in the ejector refrigeration circuit 10, and inertial force of the refrigerant flowing out of the ejector 15 becomes a specified value. As a result, the refrigerant flowing out of the diffuser portion 15d tends to be concentrated in a part of the ejector discharge-side chamber 23c away from the ejector 15, i.e., at the other end of the ejector discharge-side chamber 23c in the longitudinal direction.

Furthermore, the refrigerant does not reach an area away from the ejector 15 in an operational condition (e.g., in winter) in which the thermal load of the ejector refrigeration circuit 10 is extremely small, the volume of the refrigerant circulating in the ejector refrigeration circuit 10 is extremely small, and a flow speed of the refrigerant flowing out of the ejector 15 is extremely slow. As a result, the refrigerant flowing out of the diffuser portion 15d tends to be concentrated in a part of the ejector discharge-side chamber 23c near the ejector 15, i.e., at the one end of the ejector discharge-side chamber 23c in the longitudinal direction.

When the refrigerant is concentrated in a specified area in the ejector-discharge-side chamber 23c, the refrigerant may flow into the discharge-side distribution chamber 72b via the refrigerant communication paths 72c formed near the specified area. As such, a distribution may occur in the refrigerant in the discharge-side distribution chamber 72b. The distribution may result in variation in flow rates of the refrigerant flowing from the discharge-side distribution chamber 72b into the discharge-side tubes 71. Accordingly, the occurrence of the distribution in temperature of the air cooled in the discharge-side evaporator 17 may not be suppressed.

When the distribution in the temperature of the air cooled in the discharge-side evaporator 17 occurs, an occurrence of distribution in temperature of the air cooled by a whole of the evaporator unit 20 may not be suppressed sufficiently even if the upstream superheated area SH1 and the downstream superheated area SH2 are formed not to overlap with each other when viewed along the flow direction of the air.

However, since the evaporator unit 20 in the present embodiment has the plate member 93 serving as the partition plate, the discharge-side distribution chamber 72b can be divided into the ejector-side distribution chamber 721b and the tube-side distribution chamber 722b. As such, the refrigerant in the ejector discharge-side chamber 23c of the ejector tank 23 flows into the ejector-side distribution chamber 721b temporary.

Therefore, even if the refrigerant is concentrated to a part of the ejector discharge-side chamber 23c, the refrigerant in the part of the ejector discharge-side chamber 23c can be prevented from flowing into the discharge-side tubes 71 near the part of the ejector discharge-side chamber 23c directly.

Furthermore, the total of the open areas of the second discharge-side communication holes 93d in each of the first portion EF1 near the ejector 15, the third portion EF3 at the center of the ejector discharge-side chamber 23c in the longitudinal direction, and the fifth portion EF5 away from the ejector 15 is greater than the total of the open areas of the second discharge-side communication holes 93d in each of the second portion EF2 and the fourth portion EF4.

As such, even if the refrigerant is concentrated in any areas of the ejector discharge-side chamber 23c, the refrigerant in the ejector discharge-side chamber 23c can be distributed to a whole of the tube-side distribution chamber 722b via the portion of the discharge-side distribution chamber 72b in which the total of the open areas of the second discharge-side communication holes 93d is large. Accordingly, volumes of the refrigerant flowing from the tube-side distribution chamber 722b into the discharge-side tubes 71 can be substantially equal to each other.

Thus, the evaporator unit 20 in the present embodiment can suppress the occurrence of the distribution in temperature of the air cooled in the evaporator unit 20.

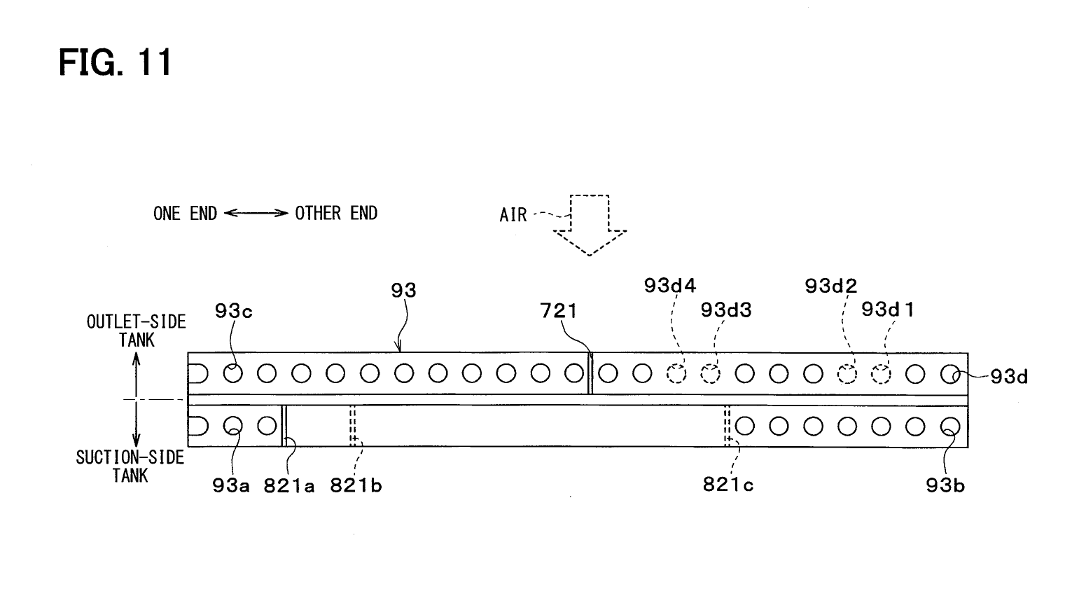

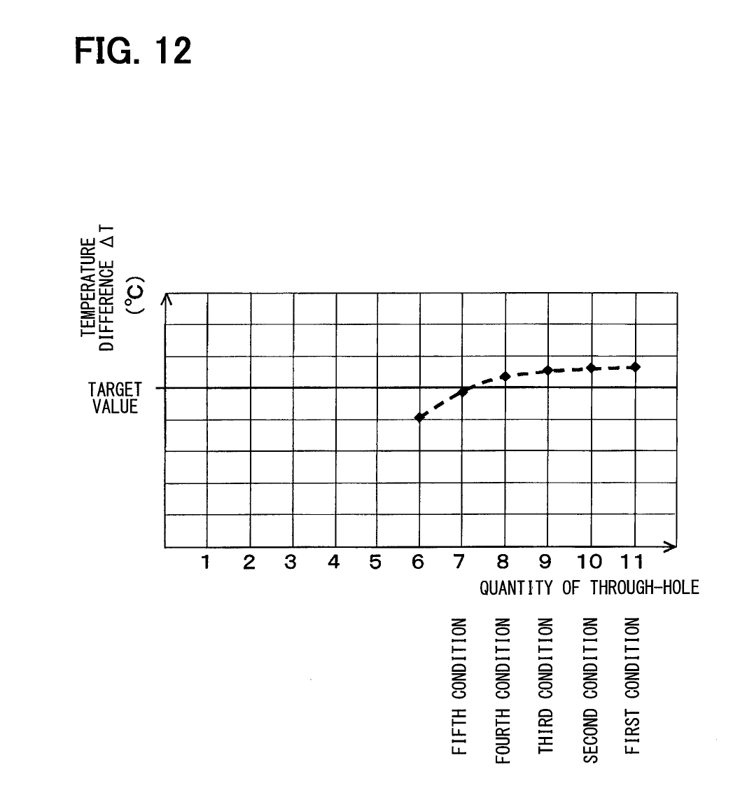

An effect in suppressing the occurrence of the distribution in temperature in the evaporator unit 20 in the present embodiment will be described in detail hereafter with reference to FIG. 11 and FIG. 12. FIG. 11 corresponds to FIG. 4. In a situation shown in FIG. 11, the second discharge-side communication holes 93d are arranged one another to be evenly spaced from each other along the longitudinal direction similar to the other communication holes (e.g., the second suction-side communication holes 93b or the first discharge-side communication holes 93c). In FIG. 11, four of the second discharge-side communication holes 93d are shown as virtual second discharge-side communication holes 93d1-93d4 and are shown by dashed circles respectively.

In FIG. 11, reference numerals 93d1, 93d2, 93d3 and 93d4 are assigned to the virtual second discharge-side communication holes respectively in this order from a downstream end of the ejector tank 23 (i.e., from the other end in the longitudinal direction). Specified conditions in which the virtual second discharge-side communication holes 93d1-93d4 are open and closed selectively are set forth below.

First condition: the virtual second discharge-side communication holes 93d1-93d4 are open (the quantity of the second discharge-side communication holes 93d is eleven)

Second condition: the virtual second discharge-side communication hole 93d1 is closed and the virtual second discharge-side communication holes 93d2-93d4 are open (the quantity of the second discharge-side communication holes 93d is ten)

Third condition: the virtual second discharge-side communication holes 93d1 and 93d2 are closed and the virtual second discharge-side communication holes 93d3 and 93d4 are open (the quantity of the second discharge-side communication holes 93d is nine)

Fourth condition: the virtual second discharge-side communication holes 93d1-93d3 are closed and the virtual second discharge-side communication hole 93d4 is open (the quantity of the second discharge-side communication holes 93d is eight)

Fifth condition: the virtual second discharge-side communication holes 93d1-93d4 are closed (the quantity of the second discharge-side communication holes 93d is seven)

As such, the total of the open areas of the second discharge-side communication holes 93d decreases as the quantity of the second discharge-side communication holes 93d decreases from the first condition to the fifth condition. Conventional evaporator units may have a structure of the first condition. On the other hand, the evaporator unit 20 in the present embodiment has a structure of the fifth condition.

FIG. 12 shows a difference ΔT in temperature of the air flowing out of the evaporator unit 20 in the first through fifth conditions. The difference ΔT in temperature is calculated by subtracting a lowest temperature of the air flowing out of the evaporator unit 20 from a highest temperature of the air flowing out of the evaporator unit 20 in each of the first through fifth conditions.

As obvious from FIG. 12, the difference ΔT in temperature decreases as the quantity, i.e., the total of the open areas, of the second discharge-side communication holes 93d decreases. That is, in the present embodiment, the plate member 93 decreases the total of the open areas of the second discharge-side communication holes 93d so that the difference ΔT becomes a target value or smaller. As such, the occurrence of the distribution in temperature of the air cooled in the evaporator unit 20 can be suppressed effectively.

More specifically, in the evaporator unit 20 in the present embodiment, the second discharge-side communication holes 93d are arranged one another to be spaced from each other un-evenly along the longitudinal direction of the ejector tank 23 and the upper discharge-side tank 72, and the total of the open areas is adjusted by forming the second discharge-side communication holes 93d in the first portion EF1, the third portion EF3 and the fifth portion EF5.

Such arrangement of the second discharge-side communication holes 93d can be obtained by closing a part of the second discharge-side communication holes 93d, which are arranged one another to be evenly spaced from each other as shown in FIG. 11, as in the first through fifth conditions. In other words, when the second discharge-side communication holes 93d are formed by a method such as punching, some of the second discharge-side communication holes 93d may be thinned, i.e., skipped.

In the evaporator unit 20 in the present embodiment, the total of the open areas of the second discharge-side communication holes 93d in the third portion EF3 is the greatest among the totals of the open areas of the second discharge-side communication holes 93d in the first portion EF1 through the fifth portion EF5. As such, even if the refrigerant is concentrated to a part of the ejector discharge-side chamber 23c, the refrigerant easily flows into a center portion of the tube-side distribution chamber 722b in the longitudinal direction. In the tube-side distribution chamber 722b, the refrigerant flows from the center portion toward one end and the other end along the longitudinal direction. As such, the refrigerant can be distributed to a whole of the tube-side distribution chamber 722b.

In the evaporator unit 20 in the present embodiment, the total of the open areas of the second discharge-side communication holes 93d is greater than or equal to the total of the open areas of the refrigerant communication paths 72c through which the ejector discharge-side chamber 23c and the discharge-side distribution chamber 72b are in fluid communication with each other. As such, even if the quantity of the second discharge-side communication holes 93d is reduced, a pressure loss caused when the refrigerant flows through the evaporator unit 20 may not increase unnecessarily.

In evaporator unit 20 in the present embodiment, the largest distance HL between the specified adjacent two holes of the second discharge-side communication holes 93d is smaller than the stacking dimension of the unit quantity (e.g., four in the present embodiment) of the discharge-side tubes 71. As such, the second discharge-side communication holes 93d are not excessively spaced from each other. Therefore, the discharge-side tubes 71 can be prevented from including tube(s) into which the refrigerant does not flow.

In the evaporator unit 20 in the present embodiment, each of the discharge-side evaporator 17 and the suction-side evaporator 18 are formed into a tank-and-tube heat exchanger. The upper discharge-side tank 72 and the upper suction-side tank 82 are formed together by the single plate header 91 and the single tank header 92. The plate member 93 is interposed between the plate header 91 and the tank header 92 to be fixed inside the discharge-side distribution chamber 72b.

As such, the plate member 93 can be fixed in the discharge-side distribution chamber 72b easily so that the plate member 93 divides the discharge-side distribution chamber 72b into the ejector-side distribution chamber 721b and the tube-side distribution chamber 722b.

### Second Embodiment

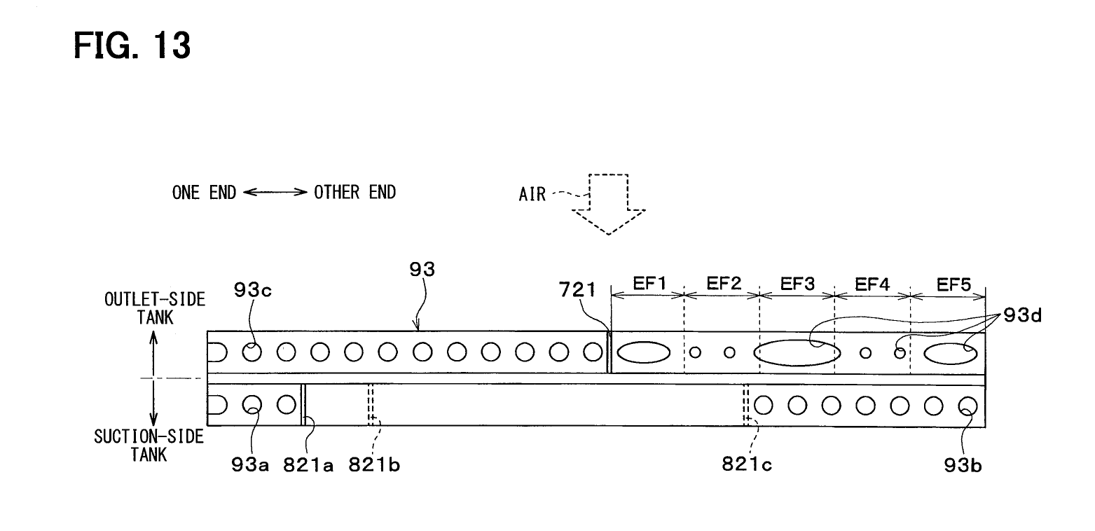

The present embodiment is different from the first embodiment in a structure that the second discharge-side communication holes 93d are arranged one another along a longitudinal direction of the plate member 93 and that the second discharge-side communication holes 93d have different open areas as shown in FIG. 13.

More specifically, an open area per one second discharge-side communication hole 93d located in the first portion EF1, the third portion EF3, or the fifth portion EF5 is greater than a total of open areas of the second discharge-side communication holes 93d located in the second portion EF2 or the fourth portion EF4.

FIG. 13 corresponds to FIG. 4 relating to the first embodiment. As such, corresponding elements or equivalent elements are assigned with the same reference numerals as the first embodiment. The same applies to the following drawings.

The remaining configurations and operation of the evaporator unit 20 and the ejector refrigeration circuit 10 are similar to those of the first embodiment. As such, the same effects as the first embodiment can be obtained in the ejector refrigeration circuit 10 in the present embodiment.

Furthermore, with the arrangement of the second discharge-side communication holes 93d in the present embodiment, the total of the open areas of the second discharge-side communication holes 93d can be adjusted as in the fifth condition described in the first embodiment. As such, according to the evaporator unit 20 in the present embodiment, the occurrence of the distribution in temperature of the air cooled in the evaporator unit 20 can be suppressed effectively similar to the first embodiment.

### Third Embodiment

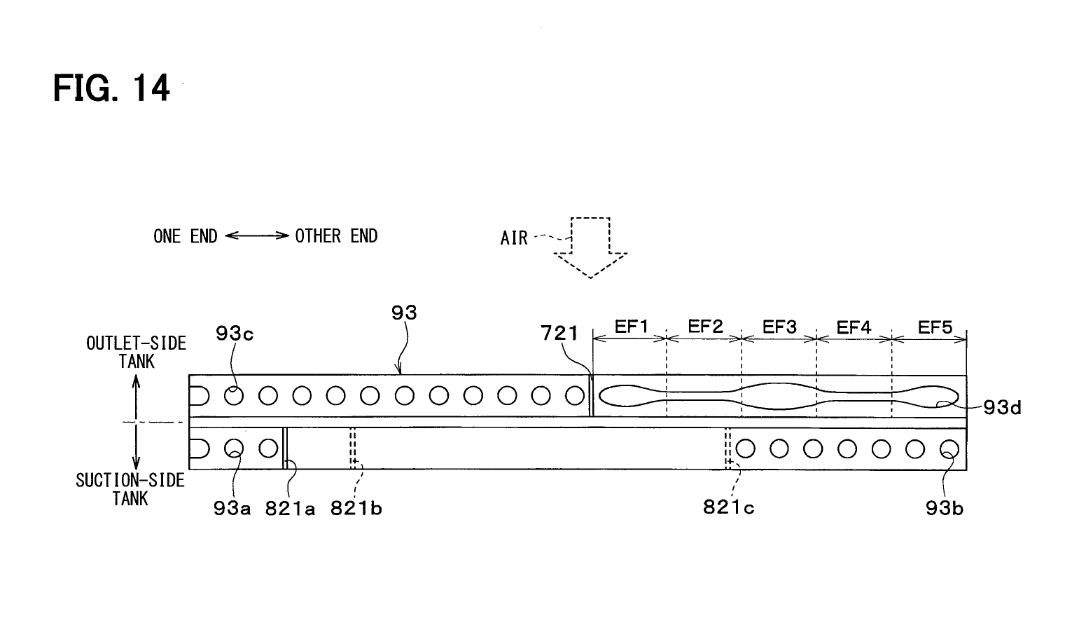

The present embodiment is different from the first embodiment in a structure that the plate member 93 includes single second discharge-side communication hole 93d as shown in FIG. 14. FIG. 14 corresponds to FIG. 4 relating to the first embodiment.

In the present embodiment, the single second discharge-side communication hole 93d is formed to have different open areas in the first portion EF1 through the fifth portion EF5 respectively. Specifically, the second discharge-side communication hole 93d has a greater open area in first portion EF1, the third portion EF3, or the fifth portion EF5 than in the second portion EF2 or the fourth portion EF4.

The remaining configurations and operation of the evaporator unit 20 and the ejector refrigeration circuit 10 are similar to those of the first embodiment. As such, the same effects as the first embodiment can be obtained in the ejector refrigeration circuit 10 in the present embodiment.

Furthermore, with the arrangement of the second discharge-side communication holes 93d in the present embodiment, the total of the open areas of the second discharge-side communication holes 93d can be adjusted as in the fifth condition described in the first embodiment. As such, according to the evaporator unit 20 in the present embodiment, the occurrence of the distribution in temperature of the air cooled in the evaporator unit 20 can be suppressed effectively similar to the first embodiment.

### Fourth Embodiment

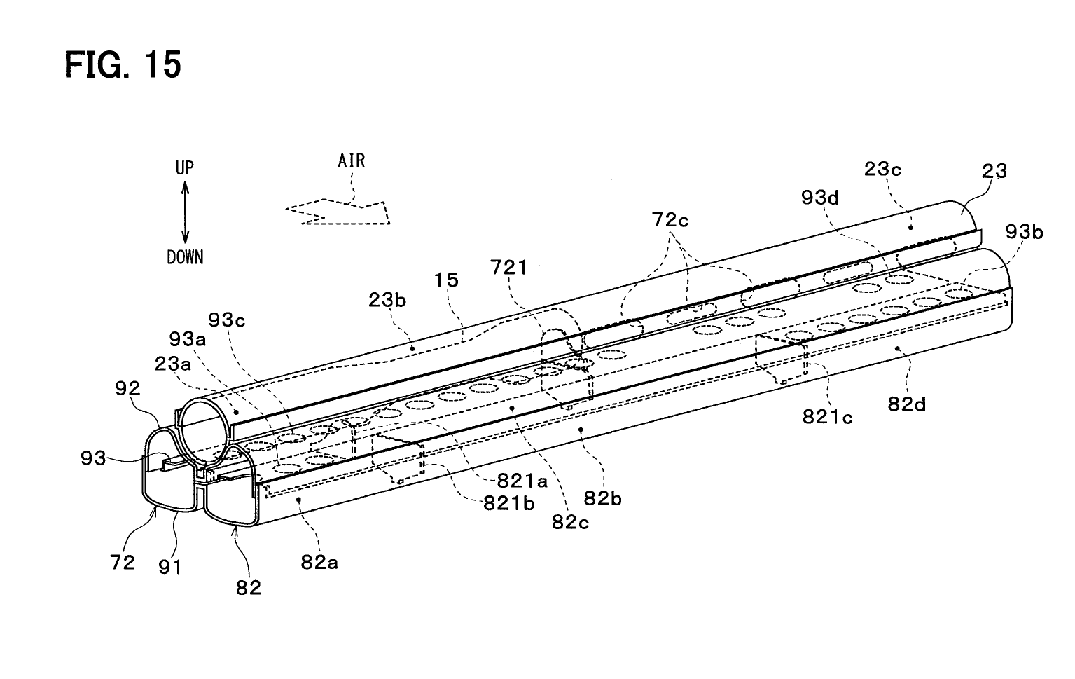

The present embodiment is different from the first embodiment in the following structure. In the present embodiment, as shown in FIG. 15, the refrigerant communication paths 72c have different open areas respectively. Specifically, the refrigerant communication path 72c near the first portion EF1, the third portion EF3, or the fifth portion EF5 of the plate member 93 has an open area greater than an open area of the refrigerant communication path 72c near the second portion EF2 or the fourth portion EF4 of the plate member 93. FIG. 15 corresponds to FIG. 3 relating to the first embodiment.

The remaining configurations and operation of the evaporator unit 20 and the ejector refrigeration circuit 10 are similar to those of the first embodiment. As such, the same effects as the first embodiment can be obtained in the ejector refrigeration circuit 10 in the present embodiment.

In the present embodiment, the refrigerant in the ejector discharge-side chamber 23c of the ejector tank 23 easily flows to the first portion EF1, the third portion EF3 and the fifth portion EF5 of the plate member 93 when guiding the refrigerant to flow into the ejector-side distribution chamber 721b of the discharge-side distribution chamber 72b via the refrigerant communication paths 72c.

As such, when the refrigerant in the ejector-side distribution chamber 721b flows into the tube-side distribution chamber 722b via the second discharge-side communication holes 93d, the refrigerant can be evenly distributed to a whole of the tube-side distribution chamber 722b more effectively. As a result, the occurrence of the distribution in temperature of the air cooled in the evaporator unit 20 can be suppressed more effectively.

### Fifth Embodiment

In the above-described embodiments, the evaporator unit 20 can suppresses the occurrence of the distribution in temperature of the air cooled in the evaporator unit 20 even if the refrigerant is concentrated to any areas of the ejector discharge-side chamber 23c. However, in the evaporator unit 20, the areas in the ejector discharge-side chamber 23c to which the refrigerant is concentrated would be changed depending on localities (i.e., places) where the evaporator unit 20 is used when operational conditions of the ejector refrigeration circuit 10 varies.

For example, in a locality having a relatively low humidity, a volume of refrigerant circulating in a refrigeration circuit would be extremely small since an air conditioner for a vehicle may be operated hardly in a humidifying and heating mode. As such, the refrigerant flowing out of the ejector 15 may be easily concentrated to an area (i.e., the other end in the longitudinal direction) of the ejector discharge-side chamber 23c away from the ejector 15 and may be hardly concentrated to an area (i.e., the one end in the longitudinal direction) of the ejector discharge-side chamber 23c near the ejector 15. When the areas in the ejector discharge-side chamber 23c to which the refrigerant is concentrated are compassable, it is preferable to form the second discharge-side communication holes 93d in a portion of the plate member 93 corresponding to the area of the ejector discharge-side chamber 23c.

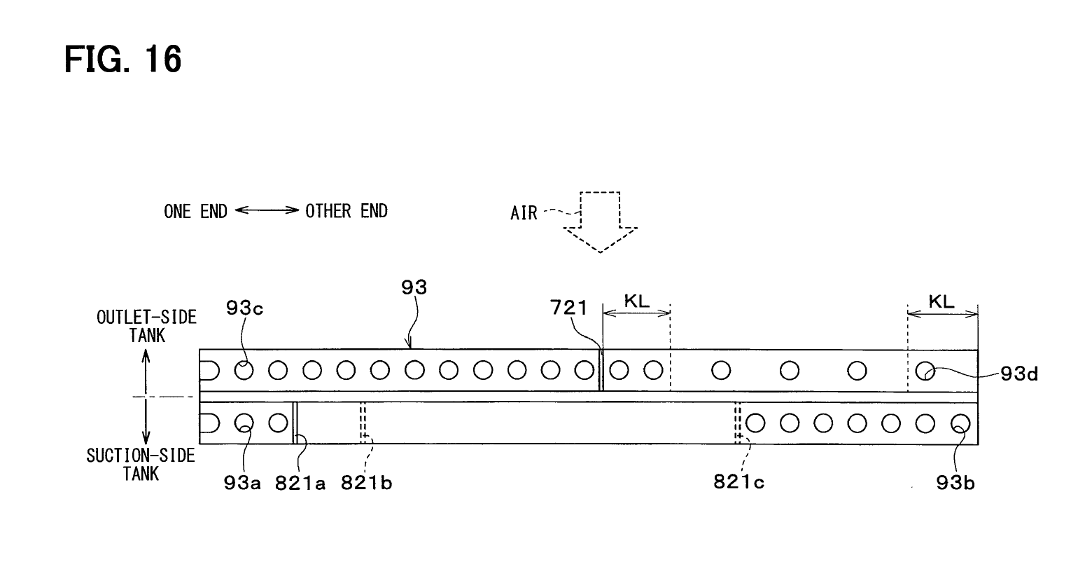

The present embodiment explains an example of the evaporator unit 20 that is used in a condition where the refrigerant flowing out of the ejector 15 tends to be concentrated to an area in the ejector discharge-side chamber 23c away from the ejector 15. As an example, the present embodiment is different from the first embodiment in a shape of the second discharge-side communication holes 93d formed in the plate member 93 of the evaporator unit 20 as shown in FIG. 16. FIG. 16 corresponds to FIG. 4 relating to the first embodiment.

As shown in FIG. 16, each of the second discharge-side communication holes 93d in the present embodiment is formed into a circular shape similar to the first embodiment. The second discharge-side communication holes 93d are arranged one another along the longitudinal direction of the plate member 93 to be spaced from each other unevenly.

Specifically, when viewed along a direction perpendicular to the longitudinal direction of the plate member 93, a distance between adjacent two holes of the second discharge-side communication holes 93d in an area near the diffuser portion 15d of the ejector 15 is shorter than a distance between adjacent two holes of the second discharge-side communication holes 93d in an area near a downstream end of the ejector tank 23 in the flow direction of the refrigerant.

As such, a total of open area(s) of one or more of the second discharge-side communication hole(s) 93d located within a specified distance KL from the refrigerant outlet of the diffuser portion 15d of the ejector 15 is greater than a total of open area(s) of one or more of the second discharge-side communication hole(s) 93d located within the specified distance KL from the downstream end of the ejector tank 23.

Therefore, the refrigerant flowing through the discharge-side distribution chamber 72b from the ejector-side distribution chamber 721b to the tube-side distribution chamber 722b easily flows through the second discharge-side communication holes 93d located near the refrigerant outlet of the diffuser portion 15d.

The specified distance KL is changeable as needed as long as the above-described relationship of the totals of open areas of the second discharge-side communication holes 93d is satisfied. That is, the specified distance KL may include a distance that does not satisfy the above-described relationship of the totals of open areas of the second discharge-side communication holes 93d is satisfied. The remaining configurations and operation of the evaporator unit 20 and the ejector refrigeration circuit 10 are similar to those of the first embodiment.

In the evaporator unit 20 in the present embodiment, the total of open area(s) of one or more of the second discharge-side communication hole(s) 93d located in an area near the refrigerant outlet of the diffuser portion 15d of the ejector 15 is greater than the total of open area(s) of one or more of the second discharge-side communication hole(s) 93d located in an area near the downstream end of the ejector tank 23.

As such, the refrigerant flowing from the ejector discharge-side chamber 23c into the ejector-side distribution chamber 721b easily flows to the area in the tube-side distribution chamber 722b near the refrigerant outlet of the diffuser portion 15d.

That is, even if the refrigerant is concentrated in an area of the ejector-side distribution chamber 721b away from the diffuser portion 15d, the refrigerant in the ejector-side distribution chamber 721b can be distributed to a whole of the tube-side distribution chamber 722b via the second discharge-side communication holes 93d. As such, volumes of the refrigerant flowing from the tube-side distribution chamber 722b into the discharge-side tubes 71 can be substantially equal to each other.

Thus, the evaporator unit 20 in the present embodiment can suppress the occurrence of the distribution in temperature of the air cooled in the evaporator unit 20 with great effect.

As described above, the evaporator unit in the present embodiment has a similar structure to the evaporator unit in the first embodiment. The evaporator unit includes communication holes (i.e., the second discharge-side communication holes 93d). An open area of a communication hole (i.e., the second discharge-side communication hole 93d) located in an area near the refrigerant outlet of a pressure increasing portion (i.e., the diffuser portion 15d) is greater than an opening area of a communication hole (i.e., the second discharge-side communication hole 93d) located in an area near the downstream end of the ejector tank 23.

As such, the occurrence of the distribution in temperature of the air cooled in the evaporator unit 20 can be suppressed effectively even if the evaporator unit 20 is used under a condition where the refrigerant flowing out of the ejector 15 is easily concentrated to the area in the ejector discharge-side chamber 23c away from the ejector 15.

In addition, in the evaporator unit 20 in the present embodiment, a quantity of the communication holes (i.e., the second discharge-side communication holes 93d) is more than one. The plurality of communication holes (i.e., the second discharge-side communication holes 93d) are arranged one another along the longitudinal direction of the discharge-side tanks 72, 73 to be spaced from each other unevenly. The distance between adjacent two holes of the plurality of communication holes (i.e., the second discharge-side communication holes 93d) located in the area near the refrigerant outlet of the pressure increasing portion (i.e., the diffuser portion 15d) is shorter than the distance between adjacent two holes of the plurality of communication holes (i.e., the second discharge-side communication holes 93d) located in the area near the downstream end of the ejector tank 23.

As an example, the plurality of communication holes (i.e., the second discharge-side communication holes 93d) may be formed in the plate member 93 by punching. The above-described arrangement of the second discharge-side communication holes 93d can be obtained easily in a manner that some of the second discharge-side communication holes 93d arranged one another to be spaced from each other evenly are skipped during the punching.

### Sixth Embodiment

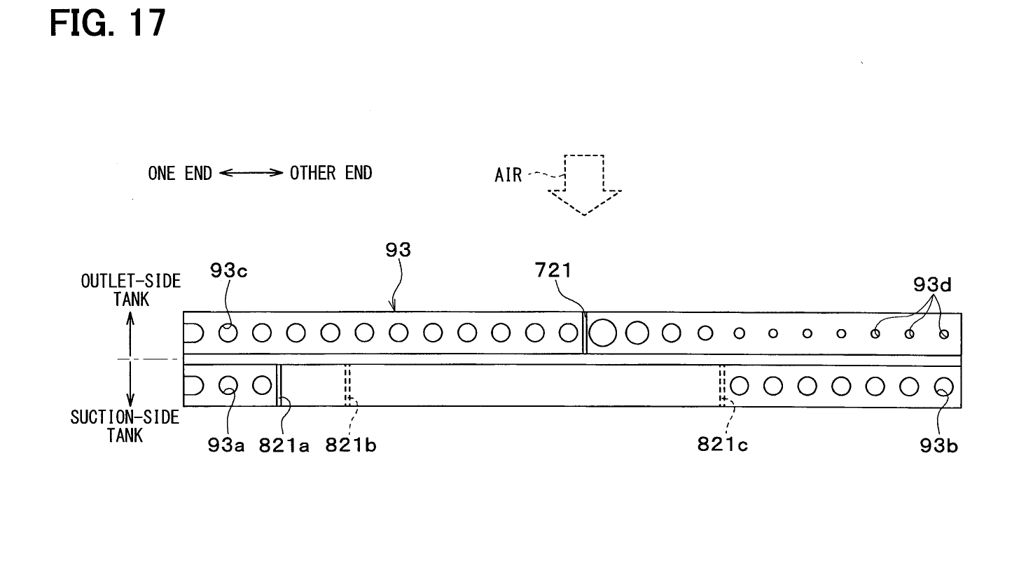

The present embodiment is different from the fifth embodiment in a structure that the second discharge-side communication holes 93d in the plate member 93d are arranged one another along the longitudinal direction of the plate member 93 to be spaced from each other evenly as shown in FIG. 17. A total of open area(s) of one or more of the second discharge-side communication hole(s) 93d located in the area near the refrigerant outlet of the diffuser portion 15d of the ejector 15 is greater than a total of open area(s) of one or more of the second discharge-side communication hole(s) 93d located in the area near the downstream end of the ejector tank 23.

More specifically, in the present embodiment, open areas of the second discharge-side communication holes 93d decrease from the one end near the refrigerant outlet of the diffuser portion 15d toward the downstream end of the ejector tank 23. FIG. 17 corresponds to FIG. 16 relating to the fifth embodiment.

The remaining configurations and operation of the evaporator unit 20 and the ejector refrigeration circuit 10 are similar to those of the fifth embodiment. As such, the same effects as the fifth embodiment can be obtained in the ejector refrigeration circuit 10 in the present embodiment.

### Seventh Embodiment

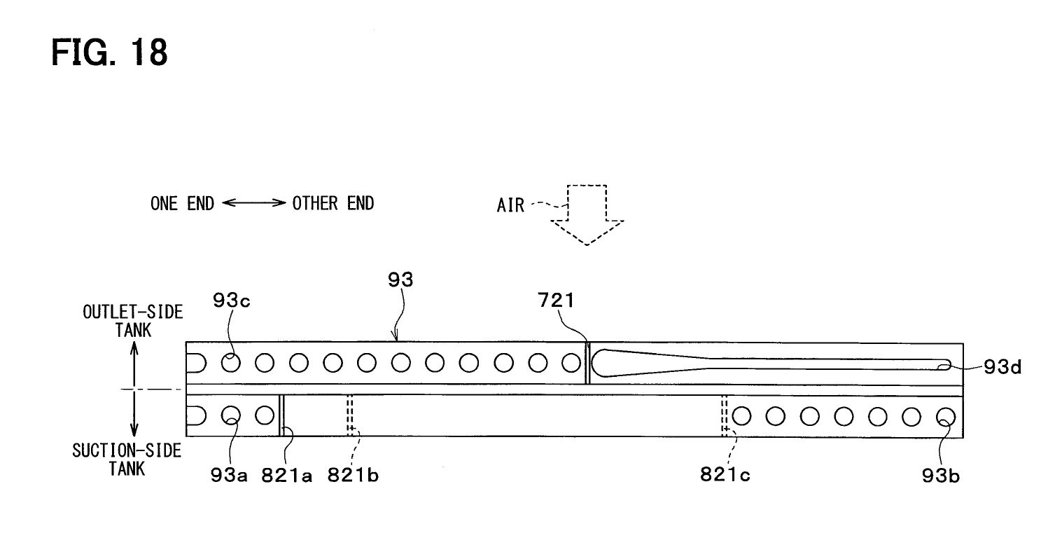

The present embodiment is different from the fifth embodiment in a structure that the plate member 93 includes single second discharge-side communication hole 93d as shown in FIG. 18.

More specifically, an open area of the second discharge-side communication hole 93d is larger in a portion between a center of the discharge-side distribution chamber 72b in the longitudinal direction and the refrigerant outlet of the diffuser portion 15d than in a portion between the center of the discharge-side distribution chamber 72b and the downstream end of the ejector tank 23. FIG. 18 corresponds to FIG. 16 relating to the fifth embodiment.

The remaining configurations and operation of the evaporator unit 20 and the ejector refrigeration circuit 10 are similar to those of the fifth embodiment. As such, the same effects as the fifth embodiment can be obtained in the ejector refrigeration circuit 10 in the present embodiment.

### Eighth Embodiment

As described in the fifth embodiment, the areas in the ejector discharge-side chamber 23c to which the refrigerant is concentrated would be changed depending on localities where the air conditioner for a vehicle is used when operational conditions of the ejector refrigeration circuit 10 varies.

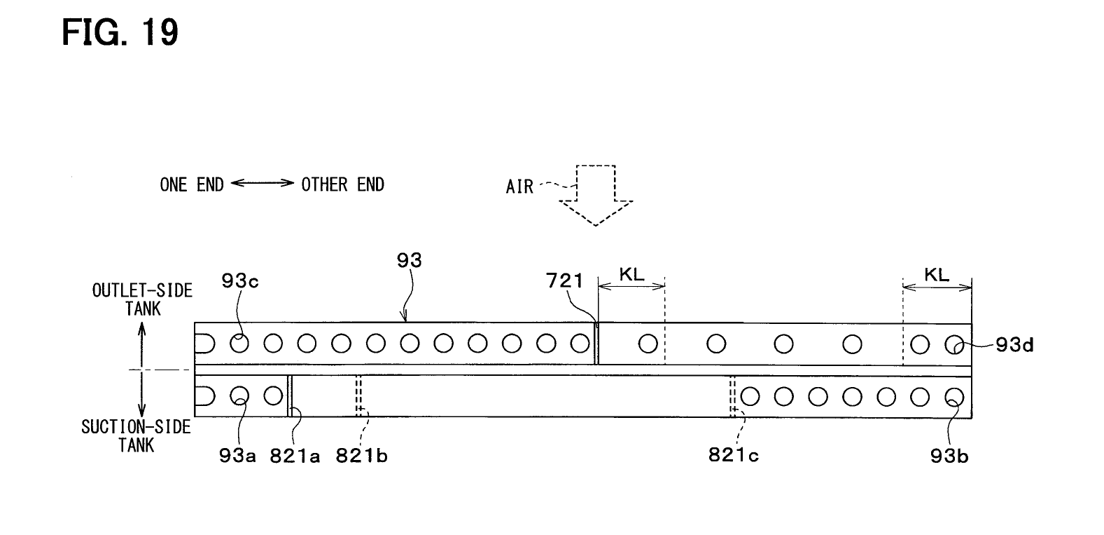

The present embodiment explains an example of the evaporator unit 20 that is used in a condition where the refrigerant flowing out of the ejector 15 tends to be concentrated to an area in the ejector discharge-side chamber 23c near the ejector 15. As an example, the present embodiment is different from the first embodiment in a shape of the second discharge-side communication holes 93d formed in the plate member 93 of the evaporator unit 20 as shown in FIG. 19. FIG. 19 corresponds to FIG. 4 relating to the first embodiment.

As shown in FIG. 19, each of the second discharge-side communication holes 93d in the present embodiment is formed into a circular shape similar to the first embodiment. The second discharge-side communication holes 93d are arranged one another along the longitudinal direction of the plate member 93 to be spaced from each other unevenly.

Specifically, when viewed along a direction perpendicular to the longitudinal direction of the plate member 93, a distance between adjacent two holes of the second discharge-side communication holes 93d in the area near downstream end of the ejector tank 23 is shorter than a distance between adjacent two holes of the second discharge-side communication holes 93d in the area near the diffuser portion 15d of the ejector 15.

As such, when the specified distance KL is set as described in the fifth embodiment, a total of open area(s) of one or more of the second discharge-side communication hole(s) 93d located within the specified distance KL from the downstream end of the ejector tank 23 is greater than a total of open area(s) of one or more of the second discharge-side communication hole(s) 93d located within the specified distance KL from refrigerant outlet of the diffuser portion 15d of the ejector 15.

Therefore, the refrigerant flowing through the discharge-side distribution chamber 72b from the ejector-side distribution chamber 721b to the tube-side distribution chamber 722b easily flows through the second discharge-side communication holes 93d located near the downstream end of the ejector tank 23. The remaining configurations and operation of the evaporator unit 20 and the ejector refrigeration circuit 10 are similar to those of the first embodiment.

In the evaporator unit 20 in the present embodiment, the total of open area(s) of one or more of the second discharge-side communication hole(s) 93d located in the area near the downstream end of the ejector tank 23 is greater than the total of open area(s) of one or more of the second discharge-side communication hole(s) 93d located in the area near the refrigerant outlet of the diffuser portion 15d of the ejector 15.

As such, the refrigerant flowing from the ejector discharge-side chamber 23c into the ejector-side distribution chamber 721b easily flows to the area near the downstream end of the ejector tank 23.

That is, even if the refrigerant is concentrated in an area of the ejector-side distribution chamber 721b near the ejector 15, the refrigerant in the ejector-side distribution chamber 721b can be distributed to a whole of the tube-side distribution chamber 722b via the second discharge-side communication holes 93d. As such, volumes of the refrigerant flowing from the tube-side distribution chamber 722b into the discharge-side tubes 71 can be substantially equal to each other.

Thus, the evaporator unit 20 in the present embodiment can suppress the occurrence of the distribution in temperature of the air cooled in the evaporator unit 20 with great effect.

As described above, the evaporator unit in the present embodiment has a similar structure to the evaporator unit in the first embodiment.

The evaporator unit includes communication holes (i.e., the second discharge-side communication holes 93d). An open area of a communication hole (i.e., the second discharge-side communication hole 93d) located in the area near the downstream end of the ejector tank 23 is greater than an opening area of a communication hole (i.e., the second discharge-side communication hole 93d) located in the area near the refrigerant outlet of the pressure increasing portion (i.e., the diffuser portion 15d).

As such, the occurrence of the distribution in temperature of the air cooled in the evaporator unit 20 can be suppressed effectively even if the evaporator unit 20 is used under a condition where the refrigerant flowing out of the ejector 15 is easily concentrated to the area in the ejector discharge-side chamber 23c near the ejector 15.

In addition, in the evaporator unit 20 in the present embodiment, a quantity of the communication holes (i.e., the second discharge-side communication holes 93d) is more than one. The plurality of communication holes (i.e., the second discharge-side communication holes 93d) are arranged one another along the longitudinal direction of the discharge-side tanks 72, 73 to be spaced from each other unevenly. The distance between adjacent two holes of the plurality of communication holes (i.e., the second discharge-side communication holes 93d) located in the area near the downstream end of the ejector tank 23 is shorter than the distance between adjacent two holes of the plurality of communication holes (i.e., the second discharge-side communication holes 93d) located in the area near the refrigerant outlet of the pressure increasing portion (i.e., the diffuser portion 15d).

As an example, the plurality of communication holes (i.e., the second discharge-side communication holes 93d) may be formed in the plate member 93 by punching. The above-described arrangement of the second discharge-side communication holes 93d can be obtained easily in a manner that some of the second discharge-side communication holes 93d arranged one another to be spaced from each other evenly are skipped during the punching.

### Ninth Embodiment

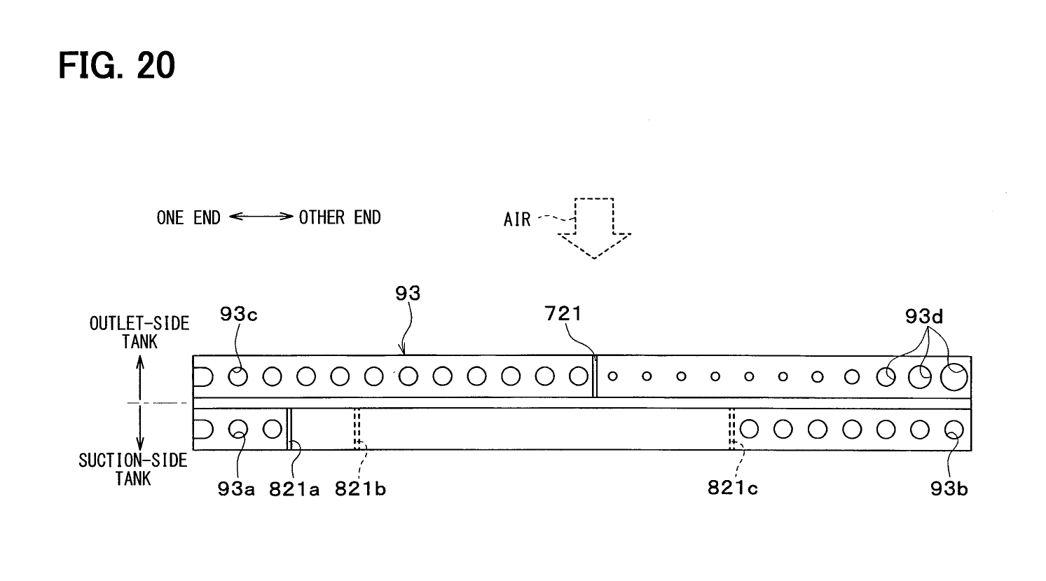

The present embodiment is different from the eighth embodiment in the following structure in the present embodiment, as shown in FIG. 20, the second discharge-side communication holes 93d in the plate member 93 are arranged one another along the longitudinal direction of the plate member 93 to be spaced from each other evenly. A total of open area(s) of one or more of the second discharge-side communication hole(s) 93d in the area near the downstream end of the ejector tank 23 is greater than a total of open area(s) of one or more of the second discharge-side communication hole(s) 93d in the area near the refrigerant outlet of the diffuser portion 15d.

More specifically, in the present embodiment, open areas of the second discharge-side communication holes 93d increase from the one end near the refrigerant outlet of the diffuser portion 15d toward the downstream end of the ejector tank 23. FIG. 20 corresponds to FIG. 19 relating to the eighth embodiment.

The remaining configurations and operation of the evaporator unit 20 and the ejector refrigeration circuit 10 are similar to those of the eighth embodiment. As such, the same effects as the eighth embodiment can be obtained in the ejector refrigeration circuit 10 in the present embodiment.

### Tenth Embodiment

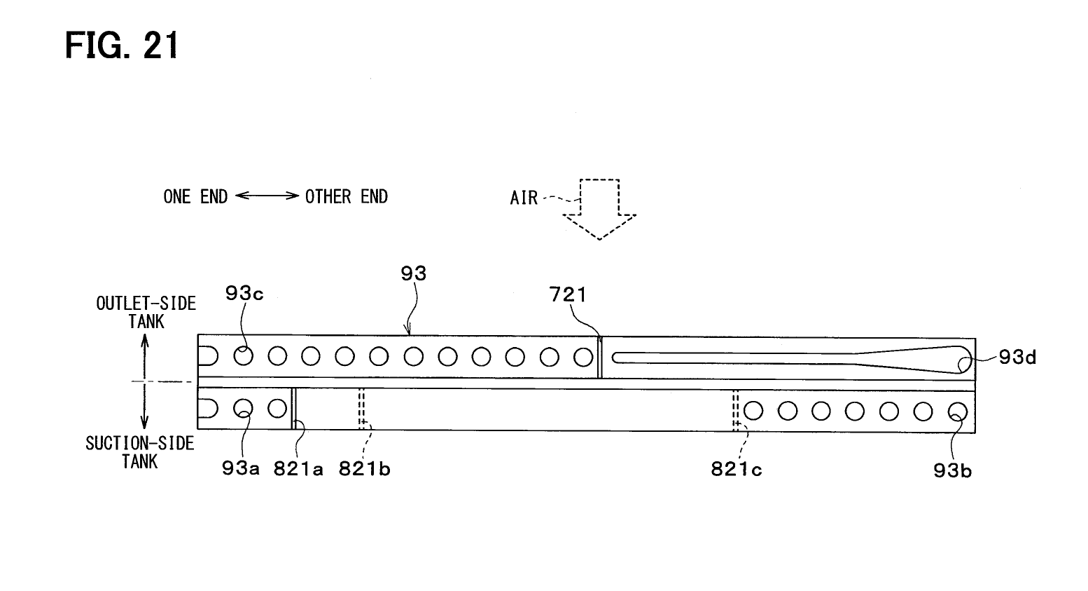

The present embodiment is different from the eighth embodiment in a structure that the plate member 93 includes single second discharge-side communication hole 93d as shown in FIG. 21.

More specifically, in the present embodiment, an open area of the second discharge-side communication hole 93d is larger in the portion between the center of the discharge-side distribution chamber 72b in the longitudinal direction and the downstream end of the ejector tank 23 than in the portion between the center of the discharge-side distribution chamber 72b and refrigerant outlet of the diffuser portion 15d. FIG. 21 corresponds to FIG. 19 relating to the eighth embodiment.

The remaining configurations and operation of the evaporator unit 20 and the ejector refrigeration circuit 10 are similar to those of the eighth embodiment. As such, the same effects as the eighth embodiment can be obtained in the ejector refrigeration circuit 10 in the present embodiment.

### Other Embodiments

The present disclosure is not limited to the embodiments described above, but can be modified in various manners within the range not departing from the purpose of the present disclosure.

(1) In the above-described first, fifth and eighth embodiments, each of the communication holes 93a-93d formed in the plate member 93 has a circular shape, however may have another shape. As an example, each of the communication holes 93a-93d may have an ellipse shape, an oval shape, or polygonal shape. The oval shape may be a shape connecting a couple of arcs with two lines extending parallel to each other.

A quantity of the communication holes 93d may be one or may be more than one.

When the quantity of the communication holes 93d is more than one, shapes or an arrangement of the communication holes 93d may be changeable as long as a total of open areas of the communication holes 93d in the first portion EF1, the third portion EF3 and the fifth portion EF5 is greater than a total of open areas of the communication holes 93d in the second portion EF2 and the fourth portion EF4.

On the other hand, when the quantity of the communication hole 93d is one, a shape of the communication hole 93d may be changeable as long as a total of open areas of portions of the communication hole 93d within the first portion EF1, the third portion EF3 and the fifth portion EF5 as a whole is greater than a total of open areas of portions of the communication hole 93d within the second portion EF2 and the fourth portion EF4 as a whole.

(2) In the fourth embodiment, each of open areas of the refrigerant communication paths 72c located in the first portion EF1, the third portion EF3, and the fifth portion EF5 is greater than each of open areas of the refrigerant communication paths 72d located in the second portion EF2 and the fourth portion EF4. However, relationship among the open areas is not limited to this example.

That is, depending on operational conditions of the ejector refrigeration circuit 10, each of the open areas of the refrigerant communication paths 72d located in the first portion EF1, the third portion EF3, and the fifth portion EF5 may be smaller than each of the open areas of the refrigerant communication paths 72d located in the second portion EF2 and the fourth portion EF4.

(3) In the above-described embodiments, the plate member 93 divides an entire of the upper discharge-side tank 72 into a lower chamber near the tubes 71 and an upper chamber away from the tubes 71 and divides an entire of the upper suction-side tank 82 into a lower chamber near the tubes 81 and an upper chamber away from the tubes 81. However, it may not be necessary to divides the entire of the upper discharge-side tank 72 and the entire of the upper suction-side tank 82.

As an example, the plate member 93 may not necessarily include portions defining the one-end-side chamber 82a and the other-end-side chamber 82d of the upper suction-side tank 82 and the discharge-side collection chamber 72a of the upper discharge-side tank 72.

As such, the plate member 93 may define only the discharge-side distribution chamber 72b in the upper discharge-side tank 72 and may divides the interior of the upper suction-side tank 82 into the four chambers of the one-end-side chamber 82a, the intermediate lower chamber 82b, the intermediate upper chamber 82c and the other-end-side chamber 82d.

(4) Elements forming the ejector refrigeration circuit 10 may not be limited to those described in the above-described embodiments.

As an example, although the compressor 11 is an electric compressor in the above-described embodiments, the compressor 11 may be an engine-drive compressor that is driven by rotational force of an engine for a vehicle transmitted from the engine to the compressor 11 via elements such as a pulley and a belt. As an example, such engine-driven compressor may be a variable-capacity compressor of which refrigerant discharge performance is variable by changing a volume of refrigerant discharged by the compressor. As another example, such engine-driven compressor may be a fixed-capacity compressor of which refrigerant discharge performance is variable in a manner that operation rates of the compressor is changed by turning on and off an electromagnetic clutch intermittently.

In the above-described embodiments, the radiator 12 is a condenser integrated with a receiver. However, the radiator 12 may be a sub-cooling condenser further integrated with a sub-cooling portion that further cools the liquid refrigerant flowing out of the receiver 12b. Alternatively, the radiator 12 may include only the condensing portion 12a. Alternatively, a reservoir (i.e., a receiver) may be further mounted to separate the refrigerant flowing out of the radiator 12 into gas refrigerant and liquid refrigerant and to discharge the liquid refrigerant to a downstream side.

In the above-described embodiments, the ejector 15 includes a fixed nozzle of which passage sectional area through which the refrigerant flows is not variable. However, the ejector 15 may include a variable nozzle of which passage sectional area through which the refrigerant flows is variable. As an example, the passage sectional area of the variable nozzle may be changed in a manner that a valve body formed into a needle or into a conical shape is disposed in a refrigerant passage defined in the variable nozzle and that the valve body is moved.

Although the refrigerant is R134a in the above-described embodiments as an example, the refrigerant is not limited to be R134a. As an example, the refrigerant may be R1234yf, R600a, R410A, R404A, R32, R407C, or the like. Alternatively, the refrigerant may be a mixture of two or more types of those refrigerants.

(5) In the above-described embodiments, the elements are integrally assembled with each other by brazing. However, the elements may be integrally assembled with each other by another method such as screwing, plastic deforming, welding, adhering, or the like. Alternatively, even if the elements are connected to each other as in the evaporator unit 20 without being integrated with each other, COP can be improved by forming the ejector refrigeration circuit.

(6) In the above-described embodiments, the evaporator unit 20 in the present disclosure is mounted to the ejector refrigeration circuit 10 for a vehicle. However, the evaporator unit 20 may be mounted to another refrigeration circuit. As an example, the evaporator unit 20 may be mounted to a stationary ejector refrigeration circuit.

(7) The features disclosed in the above-described embodiments may be combined as needed as long as practicable.

In the evaporator unit 20 in the fifth through tenth embodiments, the largest distance HL between the specified adjacent two holes of the second discharge-side communication holes 93d is smaller than the stacking dimension of the unit quantity (e.g., four in the present embodiment) of the discharge-side tubes 71 preferably. Accordingly, the discharge-side tubes can be prevented from including tube(s) into which the refrigerant does not flow, similar to the first embodiment.

In the evaporator unit 20 described in the fifth through seventh embodiments, one of the refrigerant communication paths 72c closest to the refrigerant outlet of the diffuser portion 15d has a passage cross-sectional area larger than passage cross-sectional areas of the rest of the refrigerant communication paths 72c preferably.

Accordingly, even if the refrigerant flowing from the diffuser portion 15d into the ejector discharge-side chamber 23c is concentrated in a portion of the ejector discharge-side chamber 23c away from the diffuser portion 15c, the refrigerant in the ejector discharge-side chamber 23c can be distributed to a whole of the discharge-side distribution chamber 72b easily via the refrigerant communication paths 72c having different passage cross-sectional areas.

In the evaporator unit 20 described in the eighth through tenth embodiments, one of the refrigerant communication paths 72c located furthermost from the refrigerant outlet of the diffuser portion 15d has a passage cross-sectional area larger than passage cross-sectional areas of the rest of the refrigerant communication paths 72c preferably.

Accordingly, even if the refrigerant flowing from the diffuser portion 15d into the ejector discharge-side chamber 23c is concentrated in a portion of the ejector discharge-side chamber 23c near the diffuser portion 15c, the refrigerant in the ejector discharge-side chamber 23c can be distributed to a whole of the discharge-side distribution chamber 72b easily via the refrigerant communication paths 72c having different passage cross-sectional areas.

What is claimed is:

1. An evaporator unit comprising:
an ejector including
a nozzle that reduces a pressure of a refrigerant and discharges, as an injection refrigerant, the refrigerant at a high speed and
a body that includes a refrigerant suction port drawing in the refrigerant as a suction refrigerant using suction force of the injection refrigerant and that defines a pressure increasing portion therein mixing the injection refrigerant and the suction refrigerant and increasing a pressure of the refrigerant including the injection refrigerant and the suction refrigerant;
a discharge-side evaporator that evaporates the refrigerant flowing out of the pressure increasing portion; and
a suction-side evaporator that evaporates the refrigerant and discharges the evaporated refrigerant to the refrigerant suction port, wherein
the discharge-side evaporator includes
a plurality of discharge-side tubes that are stacked one another along a stacking direction and allow the refrigerant to flow therethrough and
a discharge-side tank that collects the refrigerant flowing out of the plurality of discharge-side tubes or distributes the refrigerant to the plurality of discharge-side tubes,
the discharge-side tank extends along the stacking direction,
the discharge-side tank defines a discharge-side distribution chamber therein, the discharge-side distribution chamber takes in the refrigerant flowing out of the pressure increasing portion and distributes the refrigerant to the plurality of discharge-side tubes,
the ejector is housed in an ejector tank extending parallel to the discharge-side tank,
the ejector tank defines an ejector discharge-side chamber therein into which the refrigerant flowing out of the pressure increasing portion flows,
a partition plate is disposed in the discharge-side distribution chamber to partition the discharge-side distribution chamber,
the partition plate extends along a longitudinal direction of the discharge-side tank and divides the discharge-side distribution chamber into:
an ejector-side distribution chamber into which the refrigerant flowing out of the ejector discharge-side chamber; and
a tube-side distribution chamber from which the refrigerant flows to the plurality of discharge-side tubes,
the partition plate includes a communication hole through which the ejector-side distribution chamber and the tube-side distribution chamber are in fluid communication with each other,
the partition plate is virtually divided into five portions of a first portion, a second portion, a third portion, a fourth portion and a fifth portion arranged in this order along the longitudinal direction from an end of the partition plate adjacent to the ejector, and
the communication hole has an open area that is larger in each of the first portion, the third portion and the fifth portion than in each of the second portion and the fourth portion.

2. The evaporator unit of claim 1, wherein
the open area of the communication hole is larger in the third portion than in each of the first portion and the fifth portion.

3. The evaporator unit of claim 1, wherein
the communication hole is one of a plurality of communication holes,
the plurality of communication holes have open areas respectively that are equal to each other, and
the plurality of communication holes are arranged one another along the longitudinal direction to be spaced from each other unevenly.

4. The evaporator unit of claim 1, wherein
the communication hole is one of a plurality of communication holes, and
a portion of the plurality of communication holes within each of the first portion, third portion and the fifth portion has an open area larger than an open area of a portion of the plurality of communication holes within each of the second portion and the fourth portion.

5. The evaporator unit of claim 1, wherein
the communication hole is one of a plurality of communication holes,
the plurality of communication holes are arranged one another to be spaced from each other along the longitudinal direction,
the plurality of communication holes include specified adjacent two holes being spaced from each other by a largest distance among the plurality of communication holes, and
when a stacking dimension is defined as a length of a unit quantity of the plurality of discharge-side tubes along the stacking direction, the largest distance is smaller than the stacking dimension.

6. The evaporator unit of claim 1, wherein
the ejector discharge-side chamber and the ejector-side distribution chamber are in fluid communication with each other via a plurality of refrigerant communication paths, and
the communication hole has an open area that is greater than a total of passage cross-sectional areas of the plurality of refrigerant communication paths.

7. The evaporator unit of claim 1, wherein
the ejector discharge-side chamber and the ejector-side distribution chamber are in fluid communication with each other via a plurality of refrigerant communication paths,
the plurality of refrigerant communication paths are arranged one another along the longitudinal direction, and
a portion of the plurality of refrigerant communication paths within each of the first portion, third portion and the fifth portion has a passage cross-sectional area larger than a passage cross-sectional area of a portion of the plurality of communication holes within each of the second portion and the fourth portion.
